(19) United States
(12) Patent Application Publication
(10) Pub. No.: US 2003/0204840 A1
(43) Pub. Date: Oct. 30, 2003

(54) Apparatus and method for one-pass profiling to concurrently generate a frequency profile and a stride profile to enable data prefetching in irregular programs

(76) Inventor: Youfeng Wu, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/136,755

(22) Filed: Apr. 30, 2002

(51) Int. Cl. G06F 9/45

(52) U.S. Cl. 717/158; 717/160

(57) ABSTRACT

An apparatus and method for one-pass profiling to concurrently generate a frequency profile and a stride profile to enable pre-fetching of irregular program data are described. In one embodiment, the method includes the selective generation of stride profile information according to partially generated frequency profile information to concurrently form a stride profile and a frequency profile during execution of a user program instrumented during a single profiling pass. Once the stride profile and frequency profile are generated, prefetch instructions are inserted into the user program utilizing the stride profile and the frequency profile. In one embodiment, the present invention utilizes profiling to identify regular stride patterns in irregular program code, which is referred to herein as stride profiling. Consequently, by identifying regular stride patterns within the irregular program code, one embodiment of the invention enables prefetching of irregular program data to reduce system stalls due to data cache misses.

### FIELD OF THE INVENTION

One or more embodiments of the invention relates generally to the field of compiler optimization. More particularly, one embodiment of the invention relates to a method and apparatus for one-pass profiling to concurrently generate a frequency profile and a stride profile to enable data prefetching in irregular programs.

### BACKGROUND OF THE INVENTION

Modern computer systems spend a significant amount of time processing memory references. In fact, current systems consume an inordinate percentage of execution cycles, solely on data cache and data translation look-ahead buffers (DTLB) misses, while running irregular programs. Irregular programs refer to programs that contain irregular data references. Such irregular data references are often found in operations on complex data structures, such as pointer chasing code for linked lists, dynamic data structures or other code having irregular references. As a result, several techniques have been devised in order to provide optimizations for dealing with irregular program code containing irregular data references.

Optimizing compilers are software systems for translation of programs from higher level languages into equivalent object or binary code for execution on a computer. Current techniques are provided for compiler optimization in order to prefetch data references in order to avoid data cache misses when processing irregular program code containing irregular data references. Unfortunately, irregular data references are difficult to prefetch as the future address of a memory location is hard to anticipate by a compiler. As a result, various conventional techniques have utilized stride profiles generated by a compiler in order to guide compiler prefetching decisions.

Unfortunately, gathering of the stride profiles and additional information requires multiple compiler passes, which often place a significant burden on software development. This is especially painful for cross-compilation environments in which the compilation and execution environments are on different machines resulting in numerous manual works for executing instrumented program code in order to obtain the frequency profiles and stride profiles, as well as additional information to guide the compiler prefetching decision. Therefore, there remains a need to overcome one or more of the limitations in the above-described, existing art.

### BRIEF DESCRIPTION OF THE DRAWINGS

The various embodiments of the present invention are illustrated by way of example, and not by way of limitation, in the figures of the accompanying drawings and in which:

FIG. 1 depicts a block diagram illustrating a computer system implementing a one-pass profiling compiler to concurrently generate a frequency profile and a stride profile to enable data prefetching in irregular programs in accordance with one embodiment of the present invention.

FIG. 2 depicts a block diagram illustrating a processor, as depicted in FIG. 1, in accordance with a further embodiment of the present invention.

FIGS. 3A and 3B depict block diagrams illustrating 128-bit packed SIMD data types in accordance with one embodiment of the present invention.

FIGS. 3C and 3D depict block diagrams illustrating 64-bit packed SIMD data types in accordance with a further embodiment of the present invention.

FIGS. 4A-4C depict block diagrams illustrating program code, as well as a program flow diagram, illustrating edge as well as block frequencies of loops within the program code, in accordance with one embodiment of the present invention.

FIGS. 5A-5C illustrate flow diagrams of program loops of a user program instrumented to collect stride profile information, in accordance with one embodiment of the present invention.

FIG. 6 depicts a flow diagram illustrating an instrumented load loop of a user program to selectively collect stride profile information utilizing partially collected frequently profile information, in accordance with one embodiment of the present invention.

FIG. 7 depicts a block diagram illustrating a flow diagram of a user program load loop instrumented to collect stride profile information according to a loop prolog predicate in accordance with a further embodiment of the present invention.

FIG. 8 depicts a block diagram illustrating a user program flow diagram of a load loop containing multiple prolog blocks in accordance with a further embodiment of the present invention.

FIG. 9 depicts a block diagram illustrating a user program flow diagram of a head block load loop instrumented to selectively collect stride profile information utilizing block frequencies of each prolog block of the head block in accordance with a further embodiment of the present invention.

FIG. 10 depicts a block diagram illustrating a user program flow diagram containing a head block instrumented to selectively collect stride profile information according to frequency profile information of prolog blocks of the load loop in accordance with a further embodiment of the present invention.

FIG. 11 depicts a block diagram illustrating a user program flow diagram of a load loop instrumented to selectively collect stride profile information according to a loop predicate set within each prolog block of the load loop in accordance with a further embodiment of the present invention,

FIG. 12 depicts pseudocode for filtering stride profile information from a stride profile to form a final stride profile in accordance with one embodiment of the present invention.

FIGS. 13A and 13B depict user program flow diagrams illustrating calculation of a load loop average trip count frequency for load loops containing multiple prolog blocks, as well as multiple successor blocks, in accordance with a further embodiment of the present invention.

FIG. 14 depicts a user program flow diagram illustrating a user program load loop instrumented to collect stride profile information according to a loop predicate based on frequencies of loop prolog blocks, as well as loop successor blocks, in accordance with a further embodiment of the present invention,

FIG. 15 depicts a user program flow diagram illustrating a user program load loop instrumented to selectively collect stride profile information according to a loop predicate set according to prolog blocks of the load loop and successor blocks of the load loop in accordance with a further embodiment of the present invention.

FIG. 16 depicts a user program flow diagram illustrating a user program load loop instrumented to selectively collect stride profile information according to a loop predicate set based on prolog block frequencies and successor block frequencies in accordance with the further embodiment of the present invention.

FIG. 17 depicts a user program flow diagram illustrating instrumenting of the load loop to collect stride profile information according to a loop predicate set based on prolog block frequencies and successor block frequencies in accordance with a further embodiment of the present invention.

FIG. 18 depicts pseudocode utilized to filter stride profile information from the load loops having an average trip count frequency below a predetermined amount in accordance with the further embodiment of the present invention.

FIG. 19 depicts a timing diagram comparing embodiments of the present invention against conventional frequency profiling in accordance with a further embodiment of the present invention.

FIG. 20 depicts a timing diagram illustrating performance of the present invention against conventional frequency profiling in accordance with a further embodiment of the present invention.

FIG. 21 depicts a flowchart illustrating a method for instrumenting a user program to concurrently collect stride profile information and frequency profile information during a single compiler profiling pass in accordance with one embodiment of the present invention.

FIG. 22 depicts a flowchart illustrating an additional method for instrumenting a user program to collect frequency profile information in accordance with a further embodiment of the present invention.

FIG. 23 depicts a flowchart illustrating an additional method for instrumenting load loops within a user program to selectively collect stride profile information in accordance with a further embodiment of the present invention.

FIG. 24 depicts a flowchart illustrating an additional method for instrumenting loop prolog blocks of a selected load loop to determine an average trip count in accordance with a further embodiment of the present invention.

FIG. 25 depicts a flowchart illustrating an additional method for instrumenting the loop prolog of a selected load loop to set a loop predicate according to an average trip count frequency, as well as an execution count of a number of times the selected load loop is executed, in accordance with a further embodiment of the present invention.

FIG. 26 depicts a flowchart illustrating an additional method for instrumenting the loop prolog of a selected load loop to set a loop predicate according to an average trip count frequency and the count of a number of times the average trip count frequency exceeds a predetermined average trip count frequency in accordance with the further embodiment of the present invention.

FIG. 27 depicts a flowchart illustrating an additional method for instrumenting each loop prolog of a selected load loop to determine an average trip count frequency according to the loop prolog block frequencies, as well as successor block frequencies, in accordance with the further embodiment of the present invention.

FIG. 28 depicts a flowchart illustrating a method for collecting stride profile information and frequency profile information during a single profiling pass and utilizing the stride profile information to insert prefetch instructions within user programs in accordance with a further embodiment of the present invention.

FIG. 29 depicts a flowchart illustrating an additional method for selectively collecting stride profile information utilizing partial frequency profile information in accordance with a further embodiment of the present invention.

FIG. 30 depicts a flowchart illustrating an additional method for removing stride profile information from selected load loops of a user program to generate a final stride profile in accordance an exemplary embodiment of the present invention.

### DETAILED DESCRIPTION

A method and apparatus for one-pass profiling to concurrently generate a frequency profile and a stride profile to enable data prefetching of irregular programs are described. In one embodiment, the method includes the selective generation of stride profile information according to partially generated frequency profile information to concurrently form a stride profile and a frequency profile during execution of a user program instrumented during a single profiling pass. Once the stride profile and frequency profile are generated, prefetch instructions are inserted into a user program, utilizing the stride profile and the frequency profile. Accordingly, in one embodiment, profiling is used to identify regular stride patterns in irregular program code, which is referred to herein as “stride profiling”. Consequently, by identifying regular stride patterns within the irregular program code, one embodiment of the invention enables data prefetching within irregular programs to reduce system stalls due to data cache misses.

In the following description, for the purposes of explanation, numerous specific details are set forth in order to provide a thorough understanding of the various embodiments of the present invention. It will be apparent, however, to one skilled in the art that the various embodiments of the present invention may be practiced without some of these specific details. In addition, the following description provides examples, and the accompanying drawings show various examples for the purposes of illustration. However, these examples should not be construed in a limiting sense as they are merely intended to provide examples of the various embodiments of the present invention rather than to provide an exhaustive list of all possible embodiments of the present invention. In other instances, well-known structures and devices are shown in block diagram form in order to avoid obscuring the details of the various embodiments of the present invention.

Portions of the following detailed description may be presented in terms of algorithms and symbolic representations of operations on data bits. These algorithmic descriptions and representations are used by those skilled in the data processing arts to convey the substance of their work to others skilled in the art. An algorithm, as described herein, refers to a self-consistent sequence of acts leading to a desired result. The acts are those requiring physical manipulations of physical quantities. These quantities may take the form of electrical or magnetic signals capable of being stored, transferred, combined, compared, and otherwise manipulated. Moreover, principally for reasons of common usage, these signals are referred to as bits, values, elements, symbols, characters, terms, numbers, or the like.

However, these and similar terms are to be associated with the appropriate physical quantities and are merely convenient labels applied to these quantities. Unless specifically stated otherwise, it is appreciated that discussions utilizing terms such as “processing” or “computing” or “calculating” or “determining” or displaying” or the like, refer to the action and processes of a computer system, or similar electronic computing device, that manipulates and transforms data represented as physical (electronic) quantities within the computer system's devices into other data similarly represented as physical quantities within the computer system devices such as memories, registers or other such information storage, transmission, display devices, or the like.

The algorithms and displays presented herein are not inherently related to any particular computer or other apparatus. Various general purpose systems may be used with programs in accordance with the embodiments herein, or it may prove convenient to construct more specialized apparatus to perform the required methods. For example, any of the methods according to the various embodiments of the present invention can be implemented in hard-wired circuitry, by programming a general-purpose processor, or by any combination of hardware and software.

One of skill in the art will immediately appreciate that the various embodiments of the invention can be practiced with computer system configurations other than those described below, including hand-held devices, multiprocessor systems, microprocessor-based or programmable consumer electronics, digital signal processing (DSP) devices, network PCs, minicomputers, mainframe computers, and the like. The various embodiments of the invention can also be practiced in distributed computing environments where tasks are performed by remote processing devices that are linked through a communications network. The required structure for a variety of these systems will appear from the description below.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression.

Thus, one skilled in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

In an embodiment, the methods of the present invention are embodied in machine-executable instructions. The instructions can be used to cause a general-purpose or special-purpose processor that is programmed with the instructions to perform the methods of the present invention. Alternatively, the methods of the present invention might be performed by specific hardware components that contain hardwired logic for performing the methods, or by any combination of programmed computer components and custom hardware components.

In one embodiment, the present invention may be provided as a computer program product which may include a machine or computer-readable medium having stored thereon instructions which may be used to program a computer (or other electronic devices) to perform a process according to an embodiment of the present invention. The computer-readable medium may include, but is not limited to, floppy diskettes, optical disks, Compact Disc, Read-Only Memory (CD-ROMs), and magneto-optical disks, Read-Only Memory (ROMs), Random Access Memory (RAMs), Erasable Programmable Read-Only Memory (EPROMs), Electrically Erasable Programmable Read-Only Memory (EEPROMs), magnetic or optical cards, flash memory, or the like.

Accordingly, the computer-readable medium includes any type of media/machine-readable medium suitable for storing electronic instructions. Moreover, the present invention may also be downloaded as a computer program product. As such, the program may be transferred from a remote computer (e.g., a server) to a requesting computer (e.g., a client). The transfer of the program may be by way of data signals embodied in a carrier wave or other propagation medium via a communication link (e.g., a modem, network connection or the like).

Computing Architecture

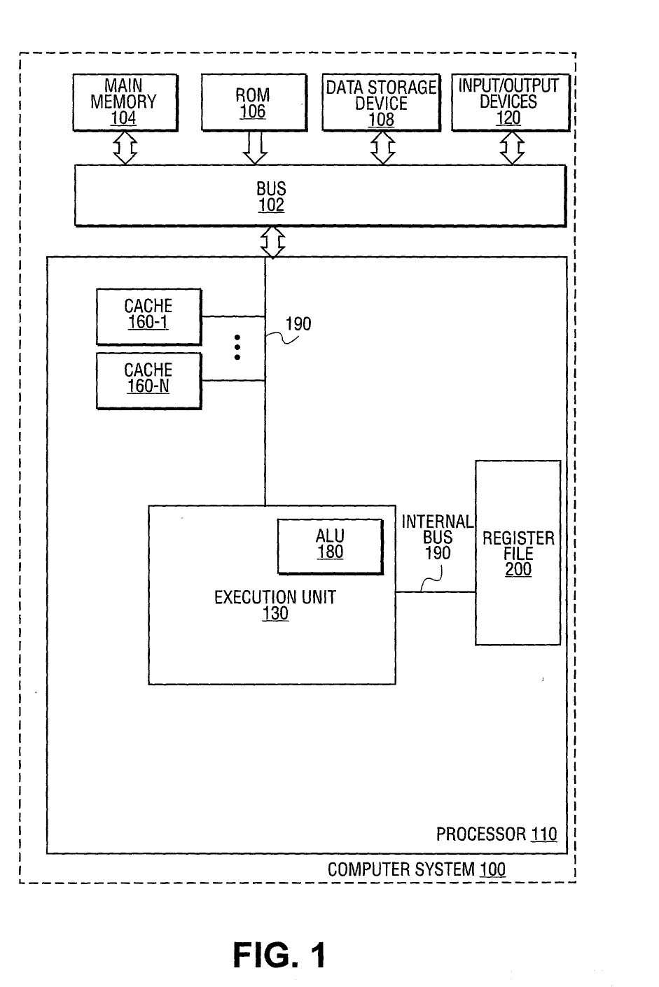

FIG. 1 shows a computer system 100 upon which one embodiment of the present invention can be implemented. Computer system 100 comprises a bus 102 for communicating information, and processor 110 coupled to bus 102 for processing information. The computer system 100 also includes a memory subsystem 104-108 coupled to bus 102 for storing information and instructions for processor 110. Processor 110 includes an execution unit 130 containing an arithmetic logic unit (ALU) 180, a register file 200, one or more cache memories 160 (160-1, . . . , 160-N).

High speed, temporary memory buffers (cache) 160 are coupled to execution unit 130 and store frequently and/or recently used information for processor 110. As described herein, memory buffers 160, include but are not limited to cache memories, solid state memories, RAM, synchronous RAM (SRAM), synchronous data RAM (SDRAM) or any device capable of supporting high speed buffering of data. Accordingly, high speed, temporary memory buffers 160 are referred to interchangeably as cache memories 160 or one or more memory buffers 160.

In one embodiment of the invention, register file 200 includes multimedia registers, for example, SIMD (single instruction, multiple data) registers for storing multimedia information. In one embodiment, multimedia registers each store up to one hundred twenty-eight bits of packed data. Multimedia registers may be dedicated multimedia registers or registers which are used for storing multimedia information and other information. In one embodiment, multimedia registers store multimedia data when performing multimedia operations and store floating point data when performing floating point operations.

In one embodiment, execution unit 130 operates on image/video data according to the instructions received by processor 110 that are included in instruction set 140. Execution unit 130 also operates on packed, floating-point and scalar data according to instructions implemented in general-purpose processors. Processor 110 as well as cache processor 400 are capable of supporting the Pentium® microprocessor instruction set as well as packed instructions, which operate on packed data. By including a packed instruction set in a standard microprocessor instruction set, such as the Pentium® microprocessor instruction set, packed data instructions can be easily incorporated into existing software (previously written for the standard microprocessor instruction set). Other standard instruction sets, such as the PowerPC™ and the Alpha™ processor instruction sets may also be used in accordance with the described invention. (Pentium® is a registered trademark of Intel Corporation. PowerPC™ is a trademark of IBM, APPLE COMPUTER and MOTOROLA. Alpha™ is a trademark of Digital Equipment Corporation.)

In one embodiment, the present invention provides stride profiling and compiler prefetching operations within a compiler system. As described in further detail below, the various operations are utilized to instrument a user program during a single compiler profiling pass, such that during execution, the user program concurrently generates a stride profile and a frequency profile. Once the stride and frequency profiles are generated, the compiler can use the stride profile and frequency profile in order to insert prefetch instructions within load loops (loops including an instruction to load data) of the user program in order to reduce program execution stalls in response to data cache misses. As described herein, embodiments of the present invention focus on loops that contain instructions to load data, which are referred to herein as “load loops”.

In one embodiment, a compiler instrumentation technique is utilized to concurrently generate a stride profile and a frequency profile during a single compiler profiling pass. During this pass, the compiler utilizes a stride profiling procedure (strideProf (ADDR)) and selectively invokes the procedure according to a loop predicate instrumentation method, as described in further detail below, in order to selectively invoke the stride profile procedure and selectively collect stride profile information. As known to those skilled in the art, “instrumenting of a program” refers to inserting of code statements within the program by the compiler to achieve a desired functionality during program execution.

In one embodiment, the compiler may also include operations for filtering partially collected stride profile information from a stride profile generated during execution of a user program instrumented during a single compiler profiling pass in order to form a final stride profile. Accordingly, once the final stride profile is generated, in one embodiment, the compiler inserts prefetching instructions within load loops of the user program, which meets certain criteria, thereby designating the load as a valid candidate for data prefetching. In one embodiment, prefetching may be performed using prefetching hardware.

Still referring to FIG. 1, the computer system 100 of the present invention may include one or more I/O (input/output) devices 120, including a display device such as a monitor. The I/O devices 120 may also include an input device such as a keyboard, and a cursor control such as a mouse, trackball, or trackpad. In addition, the I/O devices may also include a network connector such that computer system 100 is part of a local area network (LAN) or a wide area network (WAN), the I/O devices 120, a device for sound recording, and/or playback, such as an audio digitizer coupled to a microphone for recording voice input for speech recognition. The I/O devices 120 may also include a video digitizing device that can be used to capture video images, a hard copy device such as a printer, and a CD-ROM device.

Processor

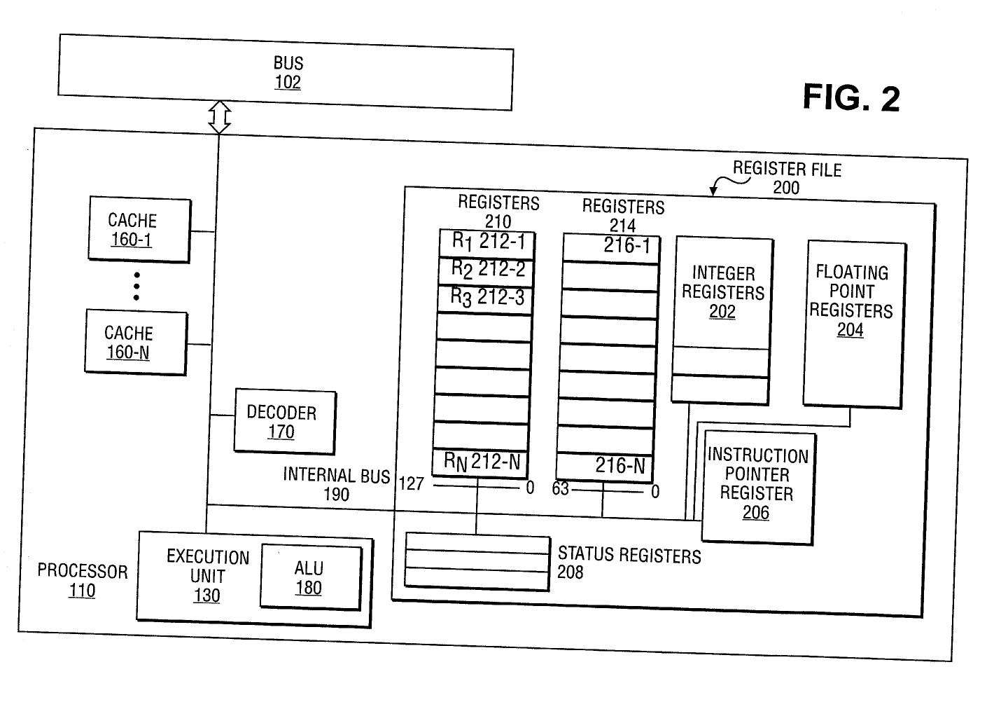

FIG. 2 illustrates a detailed diagram of processor 110. Processor 110 can be implemented on one or more substrates using any of a number of process technologies, such as, BiCMOS, CMOS, and NMOS. Processor 110 may include a decoder 170 for decoding control signals and data used by processor 110. Data can then be stored in register file 200 via internal bus 190.

As a matter of clarity, the registers of an embodiment should not be limited in meaning to a particular type of circuit. Rather, a register of an embodiment need only be capable of storing and providing data, and performing the functions described herein. In one embodiment, registers 210/214 contains eight multimedia registers, such as, for example, single instruction, multiple data (SIMD) registers containing packed data. In one embodiment, each register in registers 210/214 is either one hundred twenty-eight bits in length or sixty-four bits in length.

Execution unit 130, in conjunction with, for example ALU 180, performs the operations carried out by processor 110. Such operations may include shifts, addition, subtraction and multiplication, etc. Functional unit 130 connects to internal bus 190. In one embodiment, the processor 110 includes one or more memory buffers (cache) 160. The one or more cache memories 160 can be used to buffer data and/or control signals from, for example, main memory 104. In one embodiment, the cache memories 160 are connected to decoder 170 to receive control signals.

Data and Storage Formats

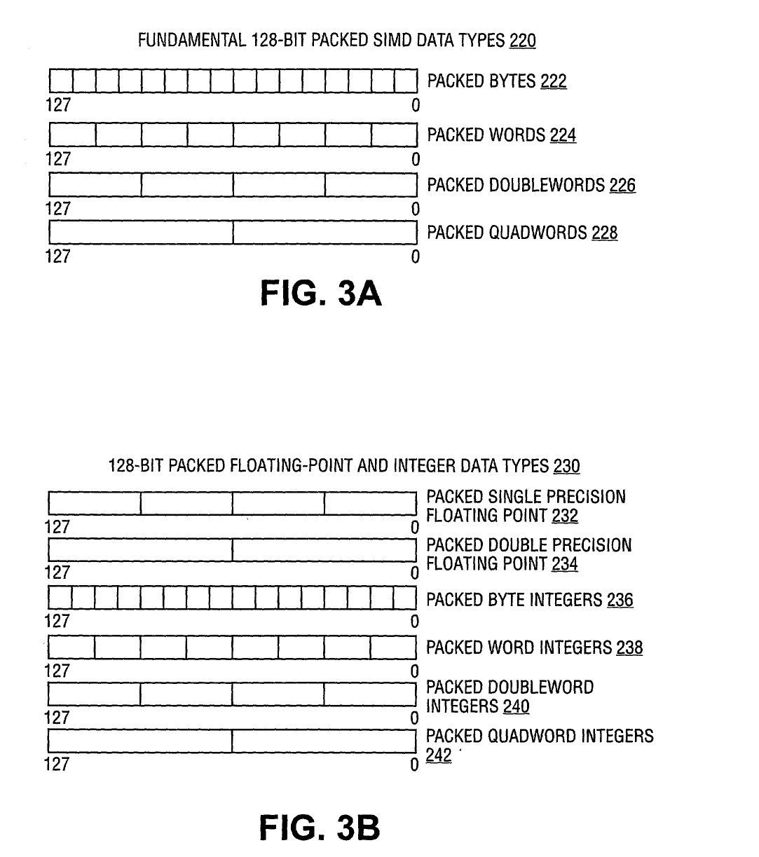

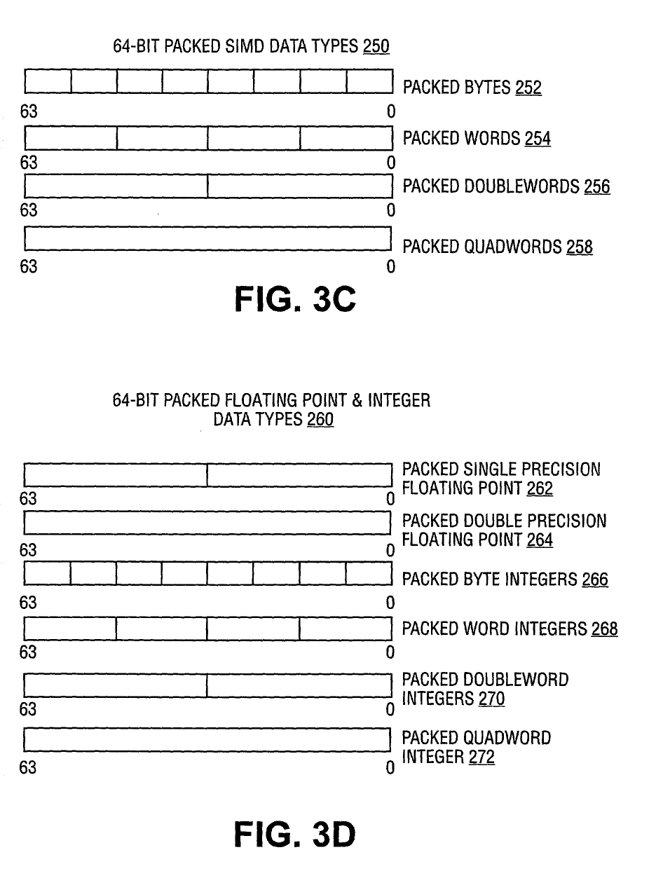

Referring now to FIGS. 3A and 3B, FIGS. 3A and 3B illustrate 128-bit SIMD data type according to one embodiment of the present invention. Generally, a data element is an individual piece of data that is stored in a single register (or memory location) with other data elements of the same length. In packed data sequences, the number of data elements stored in a register is one hundred twenty-eight bits divided by the length in bits of a data element.

Referring now to FIGS. 3C and 3D, FIGS. 3C and 3D depict blocked diagrams illustrating 64-bit packed single instruction multiple data (SIMD) data types, as stored within registers 214, in accordance with one embodiment of the present invention. As described above, in packed data sequences, the number of data elements stored in a register is 64 bits divided by the length in bits of a data element. Packed word 254 is 64 bits long and contains 4 packed word elements. Each packed word contains 16 bits of information. FIG. 3D illustrates 64-bit packed floating-point and integer data types 260, as stored within registers 214, in accordance with a further embodiment of the present invention.

Concurrent Stride/Frequency Profiling

As described above, modem computer systems spend a significant amount of time processing memory references. In fact, current systems consume an inordinate percentage of execution cycles solely on data cache and data translation look-ahead buffers (DTLB) misses while running irregular programs. Irregular programs refer to programs that contain irregular data references. Such irregular data references are often found in operations on complex data structures, such as pointer chasing code for link lists, dynamic data structures or other code having irregular references. As a result, stride profile guided prefetching of data has been devised and provides significantly improved performance on Itanium® systems as manufactured by the Intel® Corp.

As known to those skilled in the art, data prefetching refers to a technique which attempts to predict or anticipate data loads. Once the data loads have been anticipated, the data may be preloaded, or prefetched, within a temporary memory in order to avoid data cache misses. As known to those skilled in the art, a data cache miss means that the required data is not contained in a temporary data storage device, such as a data cache. As a result, the program is stalled until the data can be gathered from main memory. As recognized by those skilled in the art, substantial cache misses, have a significant detrimental effect on the execution time and efficiency of user programs. This is especially troublesome within programs containing irregular program code.

As known to those skilled in the art, a “stride” refers to a difference between two successive data addresses of successively loaded data within a user program. However, by analyzing even irregular program code, it is possible to identify stride patterns within the irregular program, wherein the difference between successive data addresses changes relatively infrequently at run time. Utilizing this information, stride profile guided prefetching may be implemented in order to avoid data cache misses of data in order to provide more efficient processing of user programs.

According to stride profile guided prefetching, a stride profile is collected by instrumenting loads that are inside a loop with an average trip count (ATC) (e.g., the average number of times the loop is executed) greater than a predetermined threshold. As known to those skilled in the art, data prefetching within loops with a low ATC is often ineffective. Accordingly, this condition, referred to herein as the average trip count condition (ATCC), is utilized to select load loops that are potentially better candidates for data prefetching.

In addition, a high trip count condition (HTCC) is described herein which refers to load loops where the average trip condition is satisfied a predetermined number of times (high trip count value). Likewise, in one embodiment, the ATCC is further conditioned on either the HTCC or an execution count indicating a number of times a load loop is executed. As described herein, calculation of the execution count to select load loops is referred to as an execution count condition (ECC).

Accordingly, for each load loop satisfying the ATCC, the compiler inserts a profile operation “strideProf(ADDR)” prior to each load inside the loop, where the “ADDR” parameter refers to the address of the data to be loaded. Consequently, when the instrumented program is executed, the routine “strideProf(ADDR)” collects stride profile information for the respective load. In alternate embodiments, the strideProf (ADDR) procedure may be further conditioned on the ATCC, the HTCC, the ECC, or a combination thereof.

As described herein, the term “loop head block” refers to the first block executed within a loop. In addition, the term “loop prolog” refers to the block prior to the loop head block. Finally, the term “successor block” refers to the block subsequent to or following the loop head block.

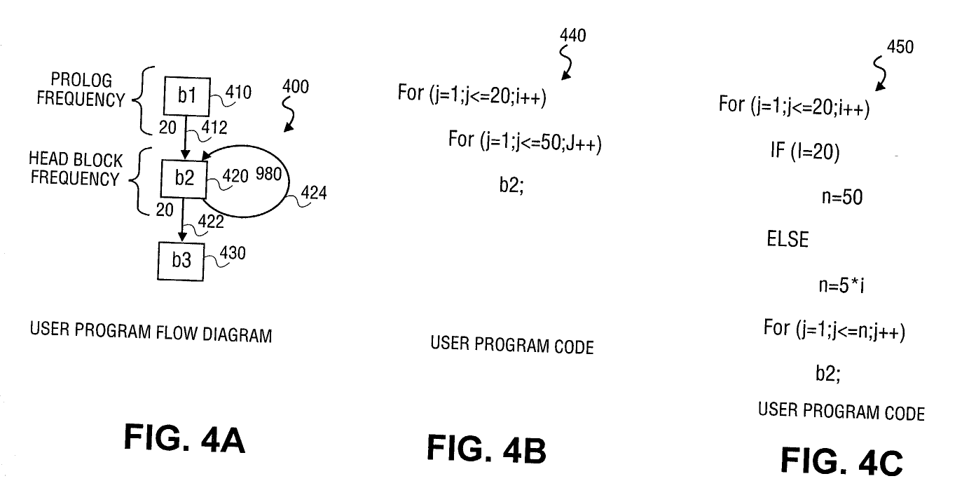

Unfortunately, the collecting of the stride profile described above assumes the availability of a frequency profile to derive the average trip count of a load loop. As described herein, the average trip count of a load loop is calculated as the ratio of the head block frequency over the epilog block frequency from outside the loop to the head block. For example, FIG. 4A depicts a user program flow diagram 400, which includes a head block (b2) 420, a prolog block (b1) 410 and another block (b3) 430. As illustrated, the prolog edge frequency 412 is 20, while the frequency of the head block is equal to the edge frequency 422 (=20) plus the edge frequency 424 (=980). Accordingly, the ATC is calculated as:

ATC=(freq(B2−>B2)+freq(B2−>B3))/freq(B1−>B2) which equals (980+20)/20=50 (1)

Accordingly, as illustrated by FIGS. 4A and 4B, the head block 420 could be the inner loop, as depicted in FIG. 4B, or as an alternate, inner loop as depicted in FIG. 4C. As illustrated by careful review of FIGS. 4B and 4C, in either case, the loop head block executes one thousand times (980+20). Consequently, since the inner loop 420 is entered 20 times in both cases, the average trip counts are 50 in both FIGS. 4B and 4C.

Conventional stride profile guided prefetching utilizes the ATCC due to the fact that the strideProf (ADDR) routine invokes an expensive profiling operation. Consequently, if every load inside every loop is instrumented to invoke the routine, the profiling overhead could be very high. Therefore, by limiting stride profiling to loads within a loop having a high average trip count, the overhead generated by the profiling routine can be significantly reduced without sacrificing the performance gain provided by prefetching guided with stride profile information.

Accordingly, in one embodiment, the present invention describes a method for concurrently generating stride profile information utilizing partially generated frequency profile information to concurrently form a stride profile and a frequency profile during a single profiling pass. In one embodiment, this is performed by invoking the stride profiling (strideProf (ADDR)) routine when the average trip count of a loop exceeds a predetermined average trip count value.

As known to those skilled in the art, a frequency profile is usually generated for compiler optimizations. Consequently, a subsequent pass following generation of the frequency profiling pass would be required to collect stride profile information using the frequency profile generated in an earlier pass to calculate average trip counts of load loops. Unfortunately, this two pass solution poses a usability problem. The additional pass to collect stride profile information places a significant burden on software development. This is especially painful for class compilation environments in which the compilations and executions are on different machines, thereby requiring lots of manual words for executing the instrumented program to obtain the various profiles.

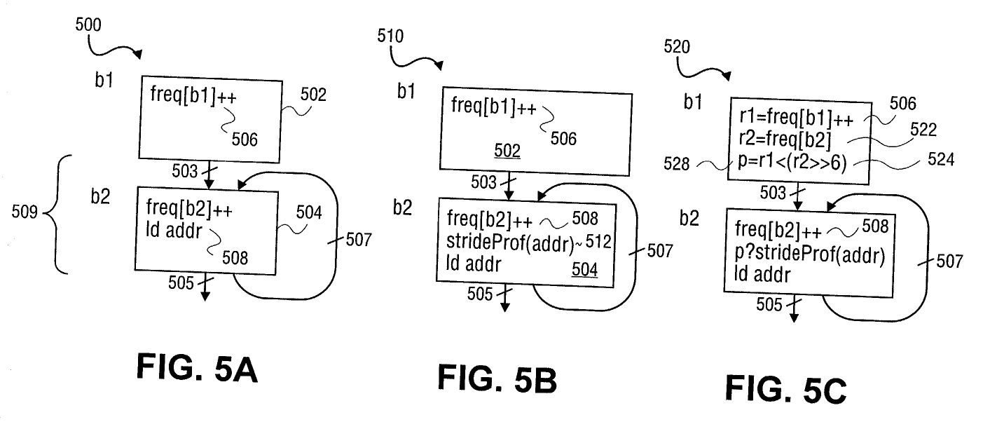

Accordingly, as described in further detail below, embodiments of the invention describe methods for selectively performing stride profiling of a user program according to an average trip count condition of data load loops within the user program as depicted in FIGS. 5A-5C. FIGS. 5A-5C illustrate flow diagrams of load loops within a user program and various embodiments for conditionally, selective stride profiling according to partially collected frequency profile information. FIG. SA depicts a flow diagram 500 of a user program load loop 509. The flow diagram 500 includes a prolog block 502 (B1) and a head block 504 (B2). As illustrated, the blocks within the program flow diagram 500 contain code for collecting frequency profile information of B1-block 502 and B2-Block 504. As illustrated, B2 block 504 would be a block selected by the concurrent frequency/stride profile generation methods of the embodiments described herein, since a data load is performed in B2 block 504.

Referring now to FIG. 5B, FIG. 5B further illustrates a flow diagram 510 of the user program, as illustrated in FIG. SA, further instrumented to include stride profile routine (strideProf(ADDR)) 512. Unfortunately, for the reasons described above, invoking the stride profile routine 512 within each load loop, irrespective of the average trip count of the load loop could result in problems with program overhead required to invoke the stride profiling routine. As a result, stride profiling is wasted within load loops having a low average trip count condition.

Accordingly, referring to FIG. 5C, FIG. 5C further illustrates a user program flow diagram 520, as depicted in FIGS. 5A and 5B, instrumented to selectively collect stride profile information according to the average trip count of load loop 509, which is comprised of edge 503, edge 505 and edge 507. In the embodiment depicted in FIG. 5C, prolog block 502 is instrumented to include a loop predicate (p), which is set when the average trip count of loop 509 exceeds a predetermined average trip count value, which in the example described is 64. As described herein, utilizing a loop predicate to selectively invoke the stride profile routine is referred to as “loop predicate instrumenting method.”

As described above, the average trip count of loop 509 would generally be calculated by dividing variable R2 by variable R1 and comparing this result to determine whether the result is greater than 64. In order to avoid multiplication and overflow, the following expression is utilized: R1<(R2>>6) to compute the equation R2>R1×64. In addition, since the prolog block 502 is much less likely to be executed than the head block 504, the equation is placed within the prolog block 502. Accordingly, the ATCC is generally checked in loop prolog blocks and the result is set into a predicate register which is used to guard against stride profile calls inside the loop body 509 and limiting such calls to load loops having an average trip count in excess of the predetermined average trip count value.

Accordingly, utilizing the embodiments depicted with reference to FIG. 5C, once a user program is instrumented, as depicted in FIG. 5C, a frequency profile and stride profile can be concurrently generated during execution of the user program. In the embodiment depicted with reference to FIG. 5C, the frequency profile generated is identical to the frequency profile generated utilizing conventional frequency profiling. However, the concurrently generated stride profile is slightly different from a stride profile collected utilizing a separate stride profiling pass. One difference results form the fact that the stride profile is activated and deactivated during different portions of the user program execution time. In other words, collecting of the stride profile information is limited to execution periods when the average trip count is high and is therefore not collected for periods when the loop trip count average is low.

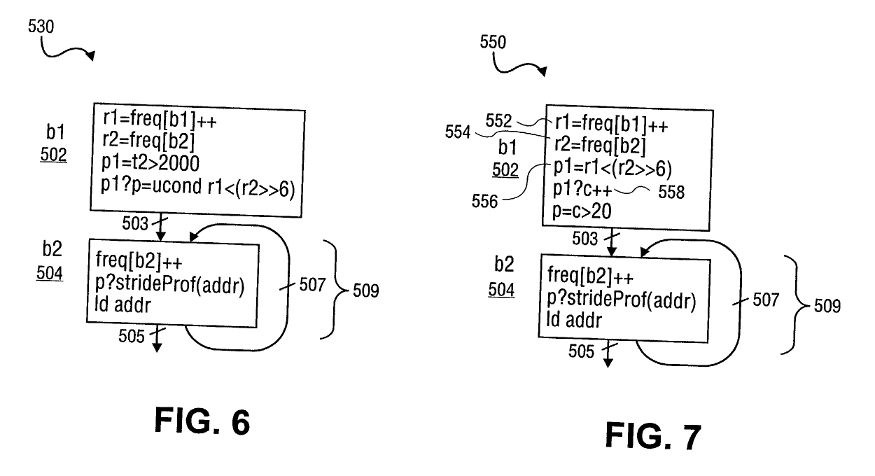

Consequently, in order to improve the quality of the stride profile which is generated in accordance with embodiments of the present invention, a further embodiment of the invention is utilized, as depicted with reference to FIG. 6. As illustrated with reference to FIG. 6, once the head block 504 has executed a predetermined number of times, a temporary predicate (pl) is set, such that the instrumented code within the prolog block 502 sets the loop predicate (p) according to the average trip count condition once temporary predicate pl is set. Accordingly, as depicted in the embodiment with reference to FIG. 6, the stride profiling routine is selectively executed according to satisfaction of both an execution count condition (ECC) of the loop head block 504, as well as the average trip count condition (ATCC).

Alternatively, as depicted with reference to FIG. 7, a user program flow diagram 550 is instrumented such that once the average trip count condition is met a predetermined number of times, the stride profiling routine is invoked every time the load loop 509 is executed. For example, as depicted with reference to FIG. 7, once the average trip count condition is met a predetermined number of times, the embodiment described invokes the stride profiling routine every time the data load loop 509 is executed.

Accordingly, as described with reference to FIG. 7, the stride profiling method continues invoking of the stride profiling routine based on the assumption that the load loop will continuously exceed he predetermined average trip count value. As a result, once the average trip count condition has been satisfied a predetermined number of times, stride profile information is continuously collected without being frequently turned on and off, as required by the methods depicted with reference to FIGS. 5C and 6. Unfortunately, utilizing the embodiment depicted with reference to FIG. 7, if the trip count of the load loop changes to a very low loop count after the initial few times (c>20), the total average trip count of the loop will be low, resulting in unnecessary execution of the stride profiling routine.

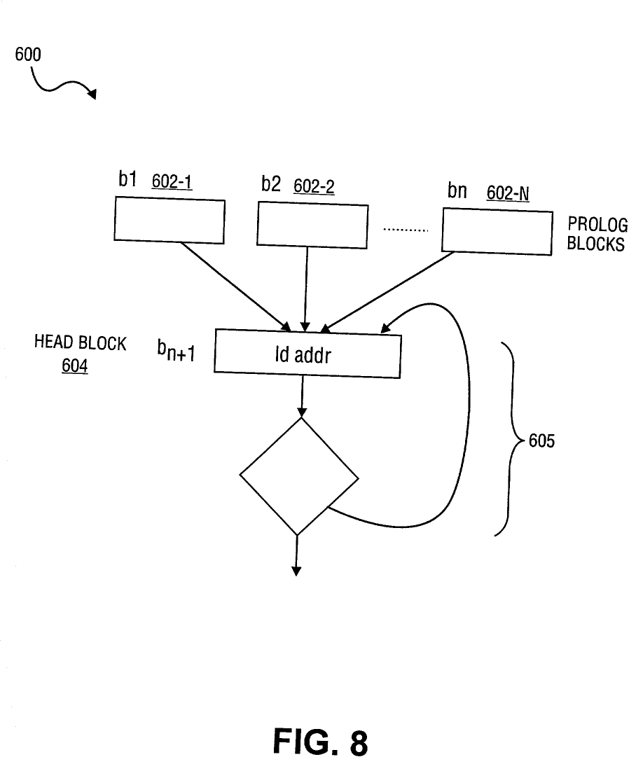

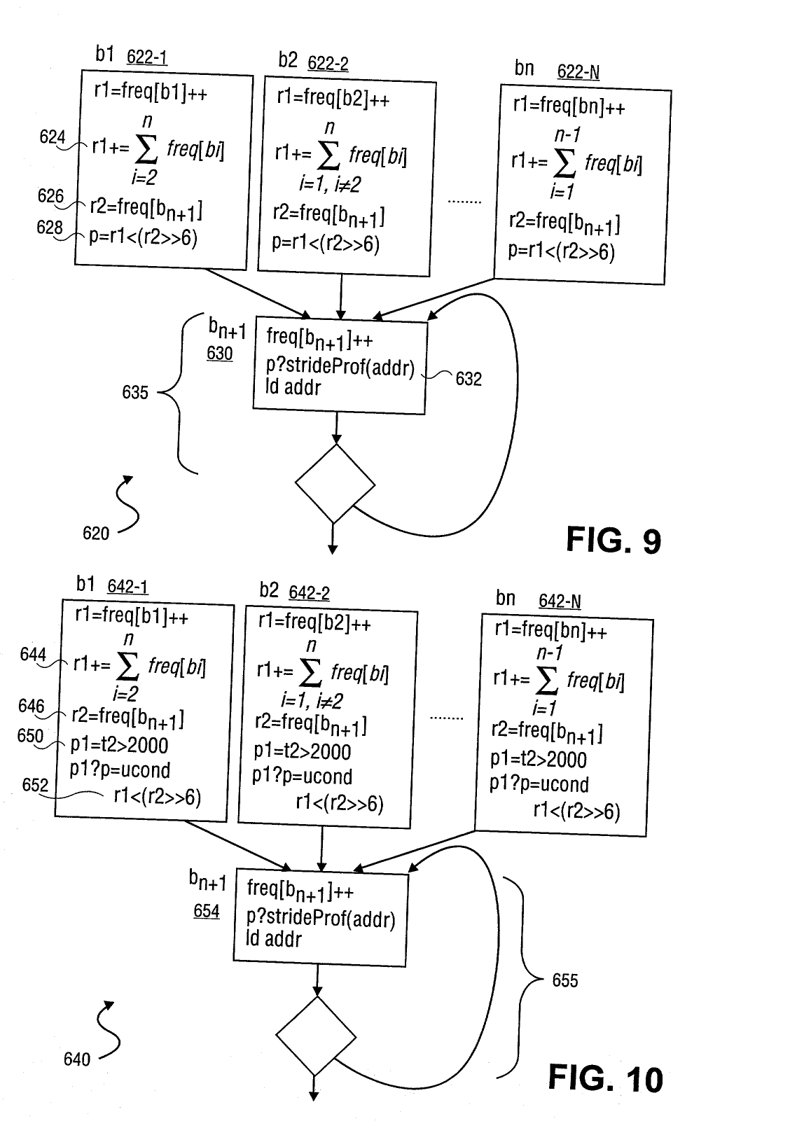

Although the user program flow diagram depicted in FIGS. 4A-7 illustrate a head block with a single loop prolog block, user programs will generally have head blocks with multiple prolog blocks, for example as depicted in FIG. 8. As depicted in FIG. 8, the user program flow diagram 600 includes a plurality of prolog blocks 602 (602-1, . . . , 602-N). In order to determine the average trip count of load loop 605, as depicted in FIG. 8, the total frequency of the loop prolog blocks is compared to the frequency of the loop head block in order to determine the ATC. Instrumentation of a loop with a head block including multiple loop prolog blocks is depicted with reference to FIG. 9.

As depicted in FIG. 9, a user program flow diagram 620 is instrumented in order to calculate the frequency total of all the prolog blocks 622 (622-1, . . . , 622-N). This frequency total is stored with the variable (R₁) 624. Accordingly, the average trip count of the load loop 635 is essentially equal to the loop head block frequency (R₂) divided by the total prolog block frequency R₁. As illustrated by equation 628, predicate (P) is stored with the result of determining whether the average trip count exceeds a predetermined average trip count value of, for example, 64. When such is the case, stride profile routine 632 is performed according to loop predicate P 628.

Accordingly, as illustrated with reference to FIG. 9, each prolog block of the user program flow diagram 620 is instrumented in accordance with the loop predicate instrumenting method, as depicted with reference to FIG. 5C. As originally depicted with reference to FIG. 5C, the loop predicate instrumenting method is utilized within the user program flow diagram 620, as depicted in FIG. 9, to invoke the stride profiling routine when the average trip count of the load loop exceeds a predetermined average trip count value, which in the embodiment described is, for example, 64.

Referring now to FIG. 10, FIG. 10 depicts a user program flow diagram 640 illustrating a head block 654 having a plurality of prolog blocks 642 (642-1, . . . , 642-N). In the embodiment depicted with reference to FIG. 10, the loop predicate instrumenting method is performed in accordance with the loop predicate instrumenting method, as depicted with reference to FIG. 6. As depicted with reference to FIG. 6, the loop predicate is conditioned not only on the average trip count exceeding a predetermined average trip count value, but is also conditioned on an execution count of the loop (ECC). Accordingly, once the loop has executed a predetermined number of times, such as for example, 2,000, the loop predicate P is set when both the average trip count exceeds a predetermined value and the loop has been executed a predetermined number of times.

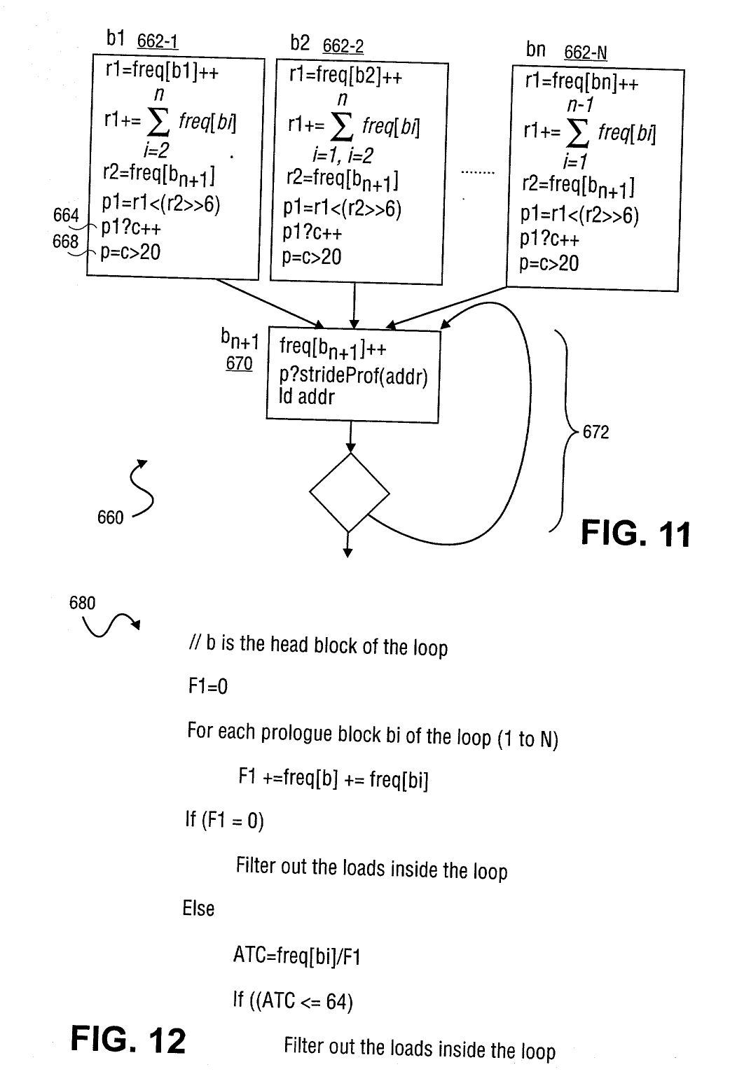

Referring now to FIG. 11, FIG. 11 depicts a user program flow diagram instrumented to invoke the stride profiling routine in accordance with the loop predicate instrumentation method as depicted with reference to FIG. 7, referred to above as the high trip count condition (HTCC). As originally depicted with reference to FIG. 7, a count is taken of the number of times the average trip count condition is satisfied. Accordingly, once the average trip count condition has been met a predetermined number of times (HTCC), for example 20, the stride profiling routine is invoked each time the load loop is executed. As described herein, the term “high trip count” indicates a number of times the average trip count exceeds the predetermined average trip count value. Accordingly, as depicted with reference to FIG. 11, head block 670 will invoke the stride profile routine each time the loop is executed once the average trip count condition has been satisfied at least 20 times.

Unfortunately, for the loop predicate instrumentation methods described in the embodiments illustrated above, a load that does not satisfy the ATCC may have partial stride profile. Accordingly, as depicted with reference to FIG. 12, FIG. 12 depicts pseudocode 680, which functions as a feedback time analysis to filter out loads inside loops with low, overall average trip counts. This pseudocode is particularly beneficial for the loop predicate instrumentation method depicted with reference to FIGS. 7 and 11, wherein the stride profile routine is invoked each time once the average trip count condition has been met a predetermined number of times.

Accordingly, utilizing the stride profile filtering pseudocode 680, as depicted with reference to FIG. 12, load loops within user programs with overall low average trip counts are filtered from the final stride profile. As a result, prefetching according to the stride profile will ignore load loops with a low average trip count. This is beneficial due to the fact that prefetching of data prior to the loads will provide limited benefit when the loop is executed a minimum number of times.

In the loop predicate instrumentation embodiments, depicted with reference to FIGS. 5C-11, instrumenting of the loop predicate, as well as calculation of the average trip count condition, was based on frequencies of the various blocks within the control flow graphs of the user program. In addition to utilizing block frequencies to perform stride profiling in accordance with the embodiments of the present invention, edge frequencies can also be used in order to determine average trip count conditions, as well as setting loop predicates in order to invoke the stride profiling routine.

As known to those skilled in the art, edge frequency profiling inserts code into each user program control flow graph edge to collect edge frequency information. Accordingly, edge frequency instrumenting is used to perform the loop predicate instrumenting methods described above to collect the average trip counts, as well as other conditions directly from the edge frequencies.

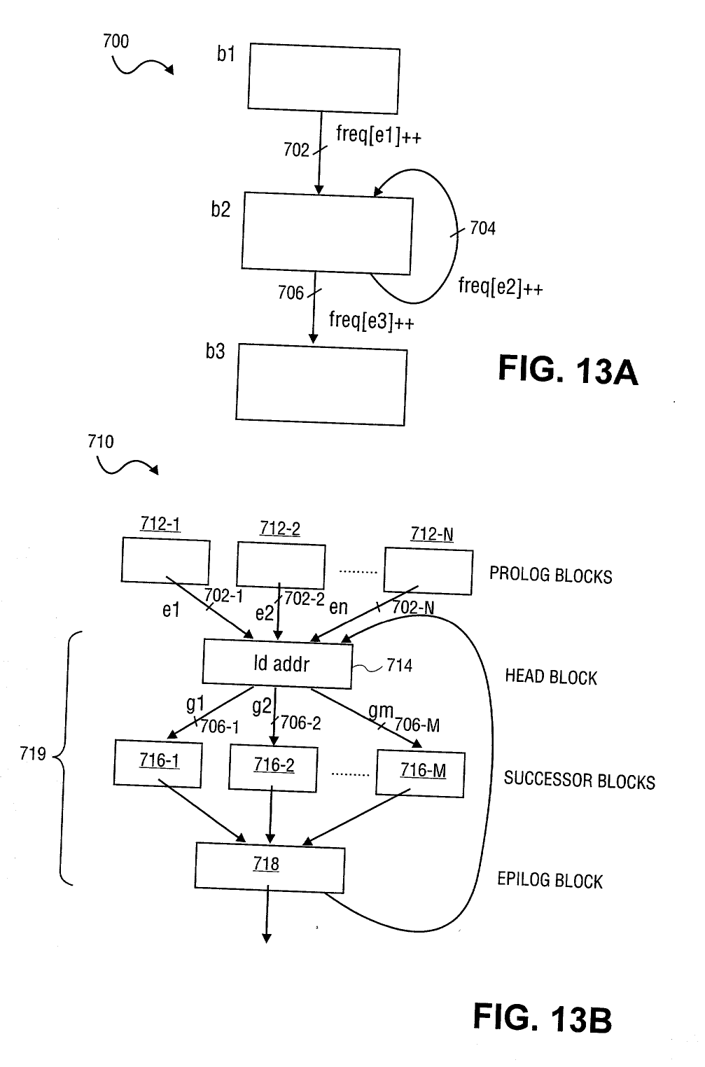

As illustrated with reference to FIG. 13A, the user program control flow graph 700 does not include a block frequency for loop head block B2. However, the loop head block frequency is simply calculated as the sum of freq(E₂) and freq(E₃). In addition, as described above and illustrated with reference to FIG. 13B, the control flow graph 710 may include a plurality of prolog blocks 712 (712-1., . . . , 712-N), a head block 714 and a plurality of successor blocks 716 (716-1, . . . , 716-M).

As illustrated with reference to FIG. 13B, the control flow graph 710 includes a plurality of edges 702 (702-1 (E₁), . . . , 702-N (E_{N})) as well as a plurality of successor block edges 706 (706-1, . . . , 706-N). In order to calculate an average trip count of load loop 719, the average trip count is calculated as a ratio of a sum of the frequency of the successor edges Gᵢ 706 and a sum of the frequency of the prolog edges Eᵢ 702. Accordingly, by dividing the frequencies of the successor edges by the frequencies of the prolog edges, the average trip count condition is determined.

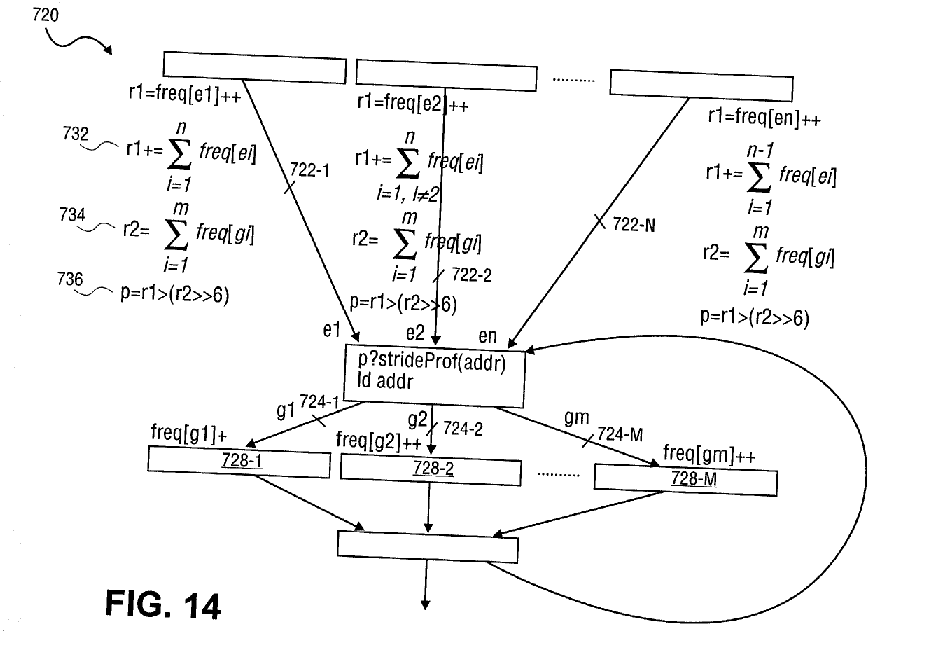

As illustrated with reference to FIGS. 14, 15 and 16, user control flow graphs 720, 740 and 750 are illustrated, implementing the loop predicate stride profiling methods as illustrated with reference to FIGS. 5, 6 and 7, utilizing edge frequencies in place of the block frequencies for determining the average trip count condition. As depicted with reference to FIG. 14, the user program control flow graph 720 instruments the loop predicate P to selectively invoke the stride profile routine based on whether the average trip count condition exceeds a predetermined trip count value, as initially described with reference to FIG. 5C. However, in contrast to FIG. 5C, the average trip count is determined as a sum of the successor edge frequencies G₁ divided by a sum of the prolog edge frequencies E₁ and compared to an average trip count value of, for example, 64.

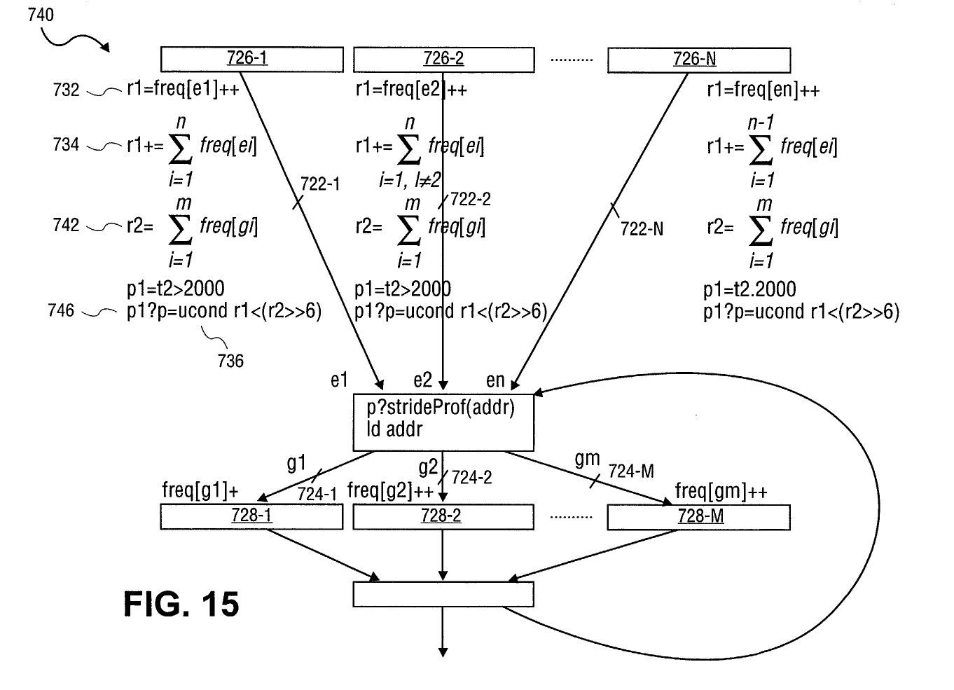

In contrast, as depicted with reference to FIG. 15, the user program control flow graph instruments 740 the loop predicate based on a dual condition of an execution count of the loop (execution count condition (ECC)), as well as the average trip count condition. Accordingly, the loop predicate instrumentation method, as described with reference to FIG. 15, is described with reference to FIG. 6, and invokes the stride profile routine once the loop has been executed a predetermined number of times. Following such execution, the stride profile is invoked when the average trip count condition exceeds the predetermined average trip count value of, for example, 64.

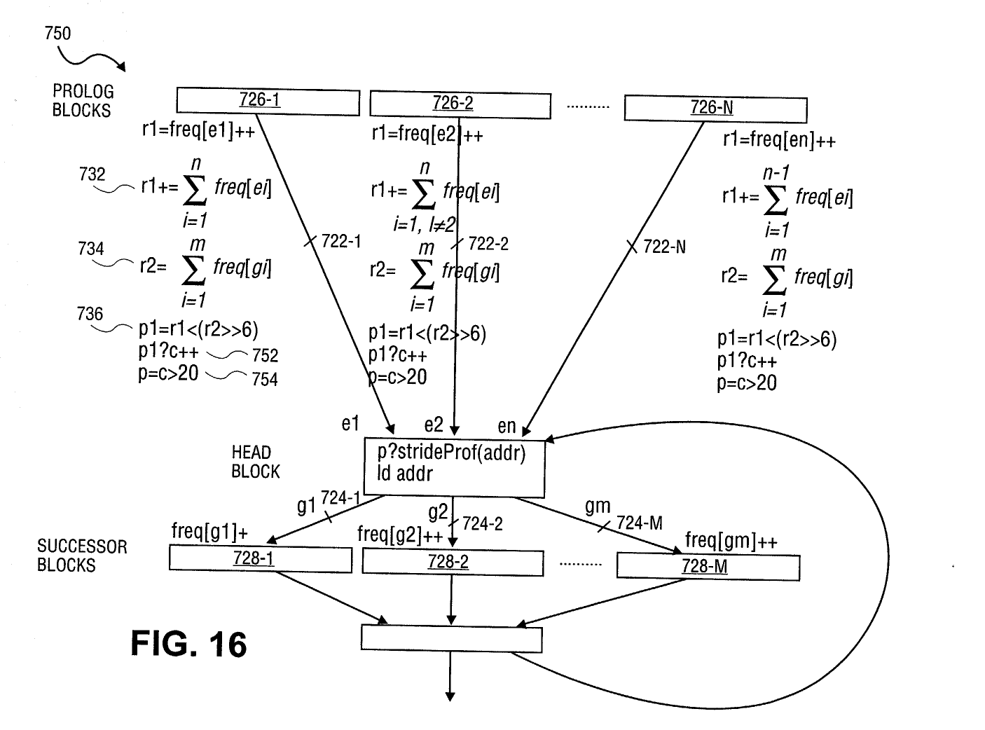

Finally, referring to FIG. 16, FIG. 16 depicts a user program control flow graph 750, which is instrumented in order to determine a count of the number of times the load loop satisfies the average trip count condition (HTCC). Once the load loop has satisfied the average trip count condition a predetermined number of times, such as for example 20, the load loop will invoke the stride profile routine each time it is invoked thereafter. Accordingly, the loop predicate instrumenting method utilized in the user program control flow block 750, as depicted with reference to FIG. 16, is roughly identical to the loop predicate instrumenting method, as originally described with reference to FIG. 7. However, the average trip count is determined based on a ratio of the successor edge frequencies divided by the prolog edge frequency.

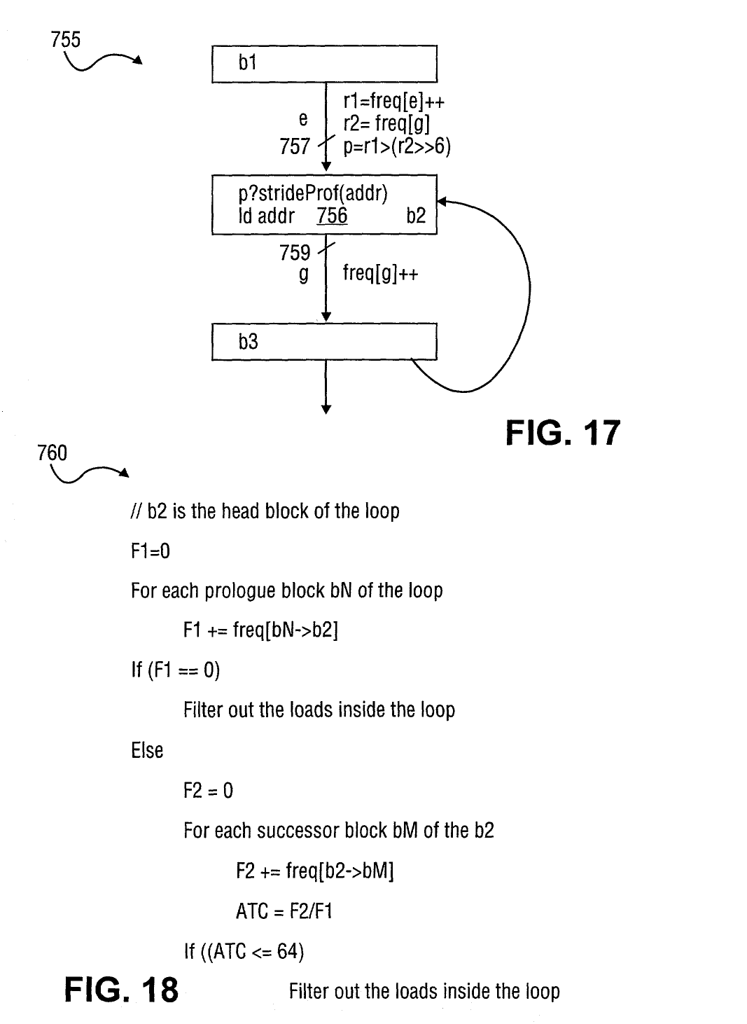

As illustrated with reference to FIG. 17, FIG. 17 depicts a simplified user program control flow graph 755. As illustrated, although the control flow graph depicted with reference to FIGS. 14-16 are quite complex, in practice, a load loop will most often contain a single prolog block and a head block will generally have one or two successor blocks. Accordingly, in a simplified control flow graph 755, as depicted with reference to FIG. 17, the prolog edge 752 is instrumented to determine whether the average trip count condition exceeds a predetermined average trip count value. Once this is the case, each execution of load loop 756 will invoke the stride profile routine.

In addition, as depicted with reference to FIG. 18, pseudocode 760 is utilized to filter stride profile information of load loops having an overall low average trip count. When a load loop has an overall low average trip count, the stride profile will only contain partial stride information for the load loop. Accordingly, in order to avoid needless data within the stride profile, the partial stride profile information is removed from the stride profile in order to generate a final stride profile.

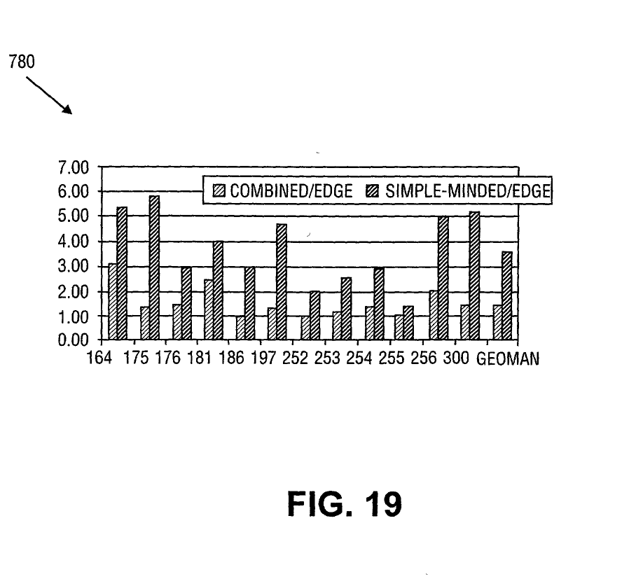

Referring now to FIG. 19, FIG. 19 depicts a graph 780, which compares non-selective stride profiling (see FIG. 5B), which invokes a stride profile routine within each load loop iteration of a user program, as compared to one loop predicate instrumentation method, as described with reference to FIG. 14. As illustrated, the graph 780 is performed by running 12 SPEC 2000 C-programs on an Itanium® system with train input. On average, the combined profiling (combined/edge) required 44 percent more time to collect both profiles than conventional one pass edge profiling. The nonselective stride (simple-minded/edge) takes 240 percent more time to collect both profiles than collecting an edge profile alone.

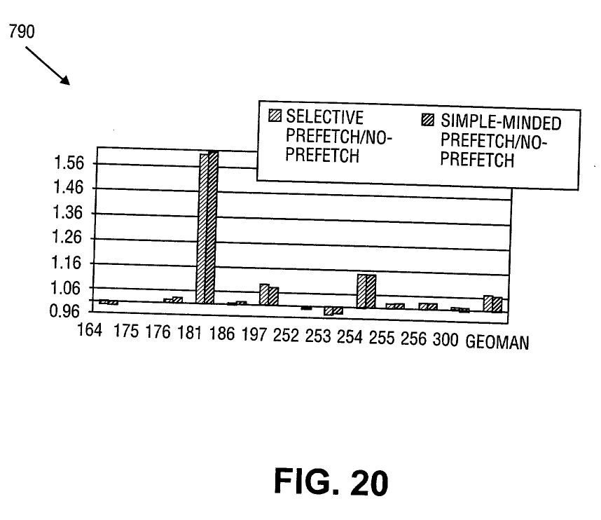

Referring to FIG. 20, FIG. 20 depicts a graph comparing the ratios of the gain provided by prefetching utilizing the selective stride profiling method (selective prefetch) over non-prefetching (non-prefetch) as compared to prefetch with the non-selective profile method (simple minded) over non-prefetching. As illustrated, FIG. 20 shows performance improvement when running SPEC 2000 C-programs with reference input using stride profiles to guide prefetching. The non-prefetching runs are performed with edge profile but not with stride prefetching. The prefetching guided with the stride profile collected using the loop predicate instrumenting methods described herein (combined edge) achieve higher speed-up than that collected with the simple minded approach, although the latter takes more time to collect. Procedural methods for implementing the various embodiments of the present invention are now described.

Operation

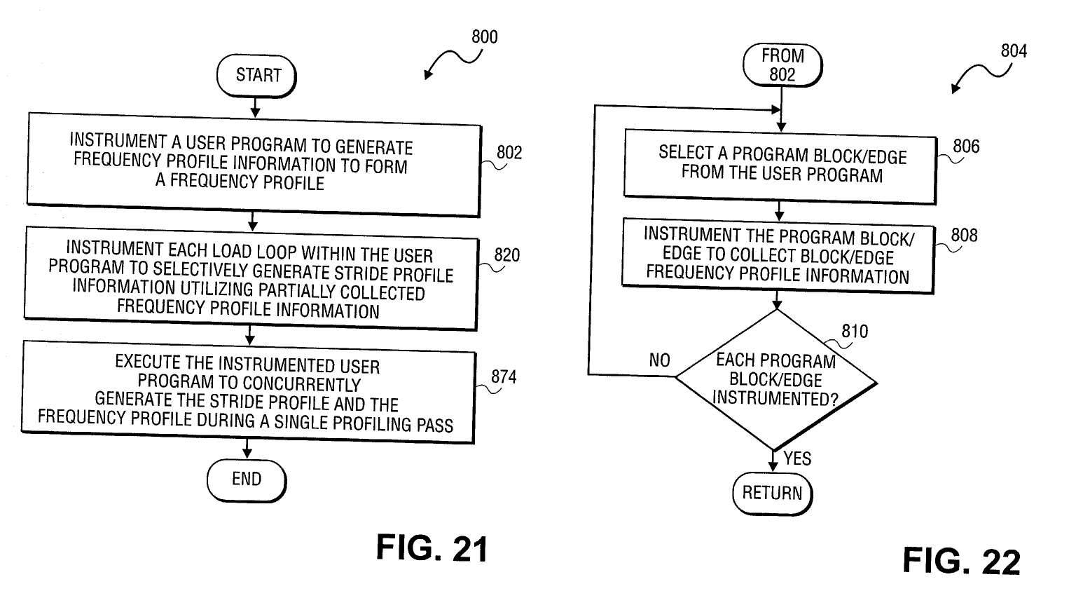

Referring now to FIG. 21, FIG. 21 depicts a method 800 for one pass profiling to concurrently generate a frequency profile and a stride profile to enable data prefetching of irregular programs within, for example, computer system 100 as depicted in FIGS. 1 and 2. As described above, current systems consume an inordinate percentage of execution cycles on data cache and DTLB misses while executing programs of an irregular nature. Irregular programs, as described above, refer to programs that contain irregular data references. As a result, various embodiments of the present invention enable the identification of regular stride patterns within irregular program code containing irregular data references in order to prefetch irregular data and reduce system stalls due to cache data misses.

As described herein, a stride refers to a distance between a current address and a previous address of a data load. However, as described above, programs containing irregular data references will contain irregular strides. However, by identifying regular stride patterns within irregular program code, prefetching of irregular program data can be performed to reduce data cache misses. Consequently, one embodiment of the present invention enables concurrent stride profiling and frequency profiling during a single compiler profiling pass in order to instrument a user program to selectively collect profile information as is now described.

At process block 802, a compiler instruments a user program to generate frequency profile information to form a frequency profile. Next, at process block 820, the compiler instruments each load loop within the user program to selectively collect stride profile information utilizing partially collected frequency profile information. Finally, at process block 874, the instrumented user program is executed to concurrently generate the stride profile and the frequency profile. In contrast to conventional techniques, the user program is instrumented during a single profiling pass. Consequently, when the program is executed, the instrumented code within the user program concurrently generates the stride profile and frequency profile.

Referring now to FIG. 22, FIG. 22 depicts an additional method for instrumenting the user program of process block 802 as depicted in FIG. 21. At process block 806, the compiler selects a program block/edge from the user program. As described above, the loop predicate implementing methods described herein can be performed utilizing block frequencies or edge frequencies. However, edge frequencies provide the additional benefit of providing the data necessary to collect or calculate block frequency information. In other words, by solely collecting edge frequency information, block frequency information can be generated from the edge frequency information.

However, as recognized by those skilled in the art, it is left to the implementation details of the various embodiments described herein as to whether to use block frequency information or edge frequency information when instrumenting loop predicates to selectively invoke stride profiling, as described in the embodiments of the present invention. Once selected, at process block 808, the compiler instruments the program block/edge to collect block/edge frequency information. Finally, at process block 810, blocks 806 and 808 are repeated for each block/edge within the user program.

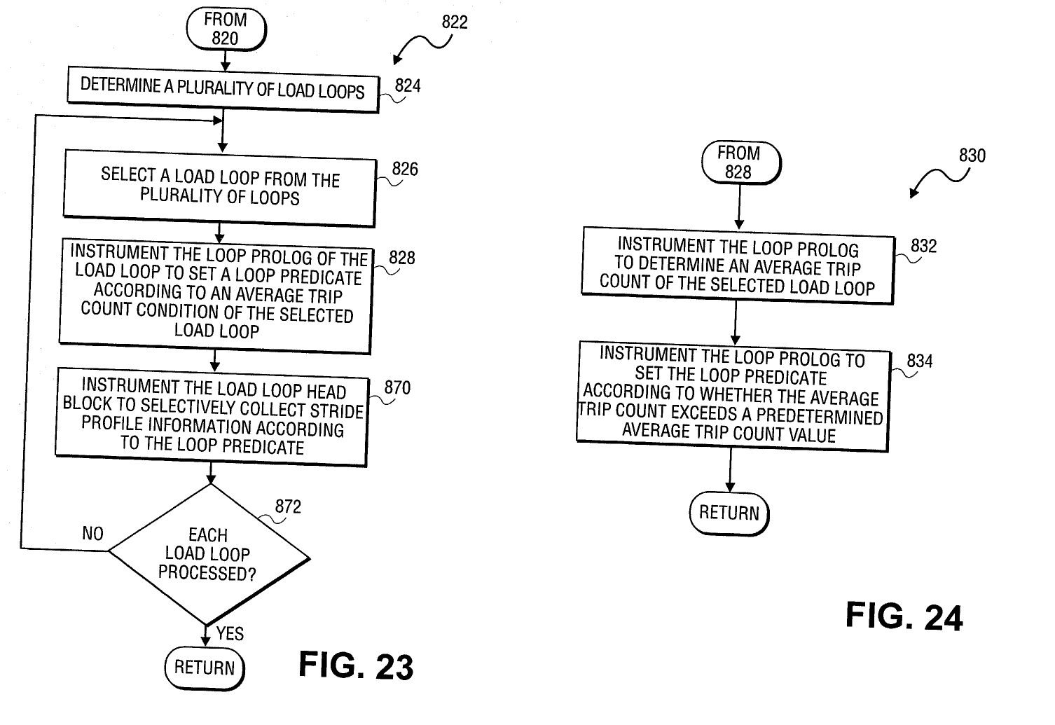

Referring now to FIG. 23, FIG. 23 depicts an additional method 822 for instrumenting each load loop within a user program of process block 820, as depicted in FIG. 21. At process block 824, the compiler will determine a plurality of load loops within the user program. As described herein, a load loop refers to a loop within a user program, wherein a data load instruction is performed. As known to those skilled in the art, load loops within user programs can be executed a substantial number of times. Consequently, such loops have a higher probability of causing data cache misses. Consequently, such load loops present a favorable area for prefetching of data in order to reduce cache misses.

Once the load loops are determined, at process block 826, the compiler selects a load loop from the plurality of determined load loops. Next, at process block 828, the compiler instruments the loop prolog of the selected load loop according to an average trip count condition of the selected load loop (ATCC). Once instrumented, at process block 870, the compiler instruments one or more loads inside the loop to selectively collect the stride profile information according to the loop predicate. Accordingly, a stride profile routine is invoked according to whether the loop predicate is set. As such, in various embodiments, the loop predicate is conditioned on the average trip count condition.

In one embodiment, the average trip count condition refers to whether the average trip count of a loop exceeds a predetermined average trip count value. As will be recognized by those skilled in the art, the average trip count value may be determined via various heuristics and techniques, as well as other means for determining the average trip count for each loop within a user program and determining a standard deviation of this average trip count to determine an overall average trip count value. However, those skilled in the art will recognize that various means may be utilized to determine a value for the average trip count value. Finally, at process block 872, process blocks 826-870 are repeated for each load loop within the user program.

Referring now to FIG. 24, FIG. 24 depicts a flowchart illustrating an additional method for instrumenting a loop prolog of the selected load loop of process block 828, as depicted in FIG. 23. At process block 832, the compiler instruments the loop prolog to determine an average trip count of the selected load loop. Next, at process block 834, the compiler instruments the loop prolog to set the loop predicate according to whether the average trip count exceeds a predetermined average trip count value (ATCC), which in one embodiment may be set to a value of, for example, 64.

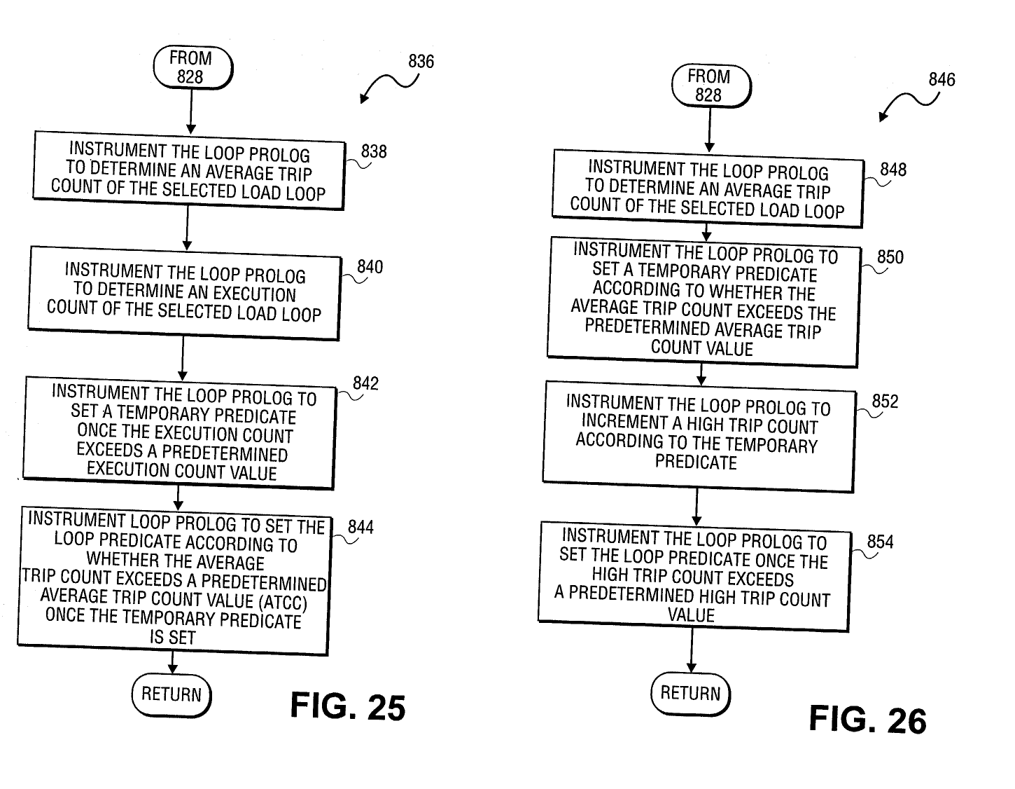

Referring now to FIG. 25, FIG. 25 depicts an additional method 836 for instrumenting the loop prolog of the selected load loop of process block 828, as depicted in FIG. 23. At process block 838, the compiler instruments the loop prolog to determine an average trip count of the selected load loop. Next, at process block 840, the compiler instruments the loop prolog to determine an execution count of the selected load loop. In the embodiment described, the execution count refers to a count of the number of times the selected load loop head block is executed. At process block 842, the compiler instruments the loop prolog to set a temporary predicate according to whether the execution count exceeds a predetermined execution count value (ECC).

Finally, at process block 844, the compiler instruments the loop prolog block to set the loop predicate according to the ATCC once the execution count exceeds a predetermined execution count value (ECC). In other words, the setting of the loop predicate is further conditioned on setting of the temporary predicate. Accordingly, in the embodiment described, the loop predicate instrumentation method is conditioned on both an execution count of the load loop (ECC), as well as the average trip count condition (ATCC). This method is premised on the idea that until a block of code has been executed a predetermined number of times, there is no need to begin collecting stride profile information for the load loop. Moreover, load loops which are executed only a few times should generally not be analyzed to determine stride profile information as these loops are not good candidates for data prefetching.

Referring now to FIG. 26, FIG. 26 depicts a flowchart illustrating an additional method for instrumenting the load loop of the selected load loop of process block 828, as depicted in FIG. 23. At process block 848, the compiler instruments the loop prolog to determine an average trip count of the selected load loop. At process block 850, the compiler instruments the loop prolog to set a temporary predicate according to whether the average trip count exceeds the predetermined average trip count value. Next, at process block 852, the compiler instruments the loop prolog to increment a high trip count according to the temporary predicate. Finally, at process block 854, the compiler instruments the loop prolog to set the loop predicate once the high trip count exceeds a high trip count value. Accordingly, the loop prolog sets the loop predicate, regardless of the average trip count, once the HTCC is met.

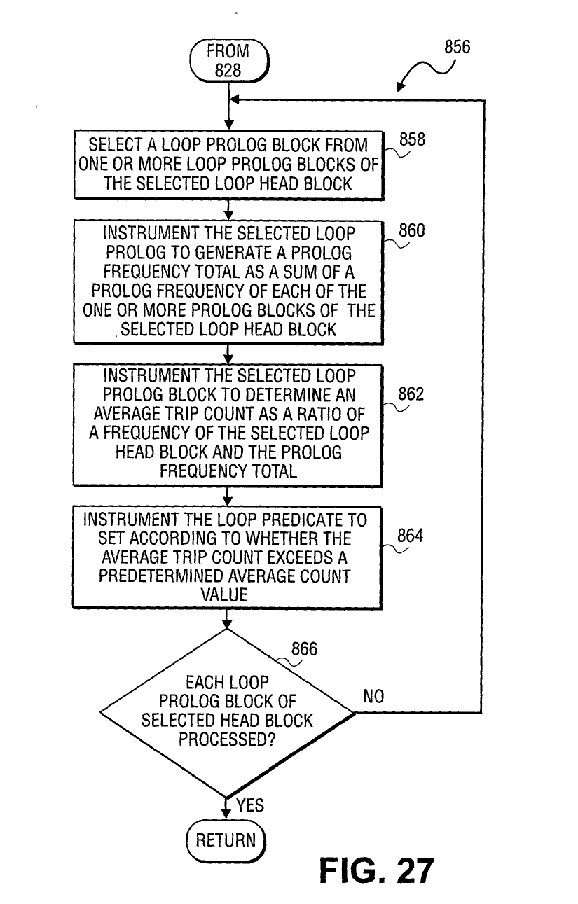

Referring now to FIG. 27, FIG. 27 depicts a flowchart illustrating an additional method 856 for instrumenting the loop prolog of the selected load loop of process block 828, as depicted in FIG. 23, for a load loop whose head block has one or more loop prologs and one or more successor blocks, for example, as depicted with reference to FIGS. 14-16. At process block 858, the compiler selects a loop prolog block from one or more loop prolog blocks of the selected loop head block. Next, at process block 860, the compiler instruments the selected loop prolog block to generate a prolog frequency total as a sum of a prolog frequency of each of the one or more prolog blocks of the selected load loop.

Once the prolog block is instrumented, process block 862 is performed. At process block 862, the compiler instruments the selected loop prolog block to determine an average trip count as a ratio of a frequency of the loop head block and the prolog block frequency total. Next, at process block 864, the compiler instruments the loop predicate to set according to whether the average trip count exceeds a predetermined average trip count value. Finally, at process block 866, process blocks 858-864 are repeated for each loop prolog block of the selected load block.

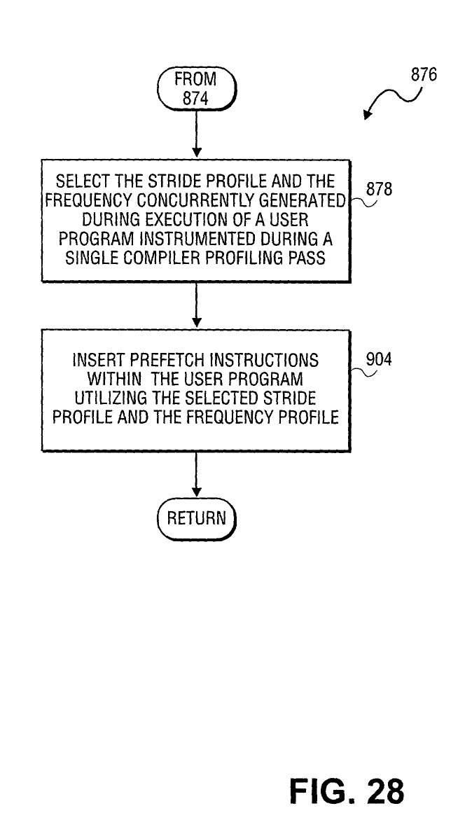

Referring now to FIG. 28, FIG. 28 depicts a flowchart illustrating an additional method for executing the instrumented user program of process block 874, as depicted in FIG. 21. At process block 878, the compiler selects a stride profile and a frequency concurrently generated during execution of the user program instrumented during a single compiler profiling pass. Finally, at process block 904, the compiler inserts prefetch instructions within the user program utilizing the stride profile and the frequency profile. Accordingly, utilizing the stride profile, the compiler is able to identify stride patterns within programs containing irregular data references and reduce cache misses to improve performance of the user program code.

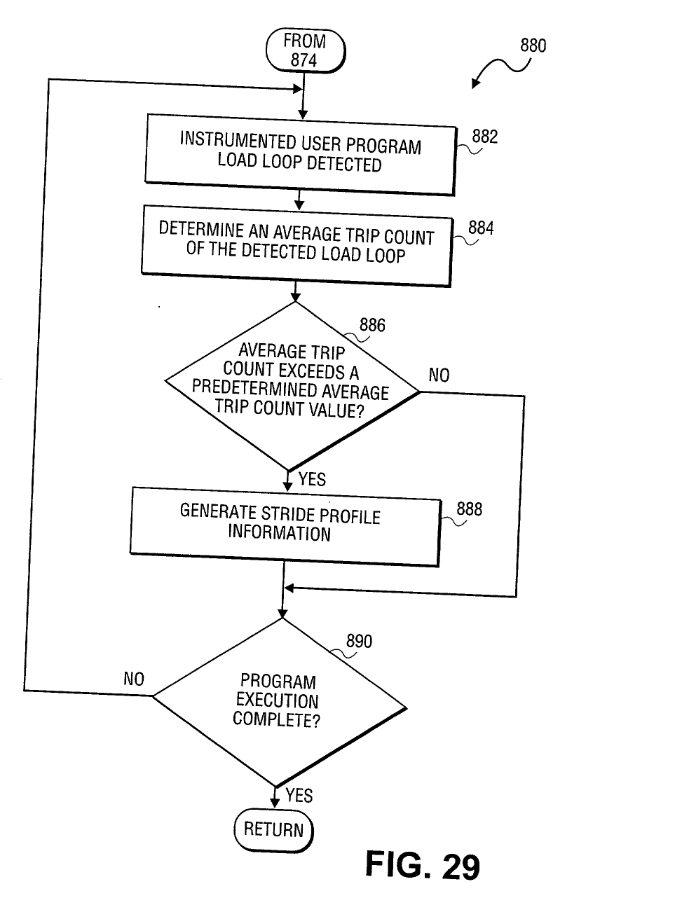

Referring now to FIG. 29, FIG. 29 depicts a flowchart illustrating an additional method 880 for selectively generating stride profile information during execution of the user program at process block 878, as depicted in FIG. 28. At process block 882, an instrumented user program loop is detected wherein a load instruction is performed. Once detected, at process block 884, an average trip count of the selected load loop is determined according to the instrumented user program. Next, at process block 886, it is determined whether the average trip count exceeds a predetermined average trip count value. When the average trip count exceeds the predetermined average trip count value, process block 888 is performed. Otherwise, control flow branches to process block 890. At process block 888, the stride profile information is generated for the detected, instrumented load loop. Finally, at process block 890, process block 882-888 are repeated for each load loop within the instrumented user program.

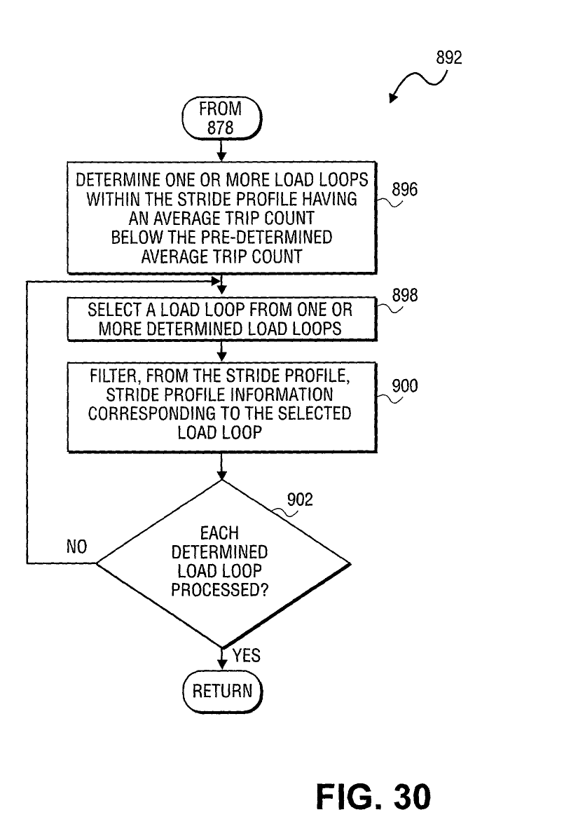

Finally, referring to FIG. 30, FIG. 30 depicts a flowchart illustrating an additional method for selectively collecting stride profile information of the instrumented user program of process block 878, as depicted in FIG. 28. As described above, the stride profile is concurrently generated along with the frequency profile. Once execution of the instrumented user program is completed, at process block 896, the frequency profile is analyzed to determine one or more loops having an average trip count below the predetermined average trip count value. Next, at process block 898, the compiler will select a load loop from one or more of the determined load loops. Once selected, at process block 900, stride profile information regarding the selected load loop is filtered from the stride profile.

Finally, at process block 902, process blocks 898-900 are repeated for each determined load loop in order to filter partial stride profile information from the stride profile in order to generate a final profile. Accordingly, utilizing the various embodiments of the present invention, a profiling compiler is described, which enables one pass instrumentation of a user program to enable concurrent generation of a stride and frequency profile. The concurrent stride and frequency profile generation method enables prefetching of irregular program data by identifying stride patterns within irregular program code. Utilizing the prefetching, cache and DTLB misses are reduced, resulting in significant performance gains in user program benchmarks.

Alternate Embodiments

Several aspects of one implementation of the stride profiling guided prefetching for providing one-pass frequency profiling to concurrently generate a frequency profile and a stride profile to enable prefetching of irregular program data have been described. However, various implementations of the one-pass frequency profiling to concurrently generate a frequency profile and a stride profile to enable prefetching of irregular program data provide numerous features including, complementing, supplementing, and/or replacing the features described above. Features can be implemented as part of the system compiler or as part of the prefetching hardware in different implementations. In addition, the foregoing description, for purposes of explanation, used specific nomenclature to provide a thorough understanding of the embodiments of the invention. However, it will be apparent to one skilled in the art that the specific details are not required in order to practice embodiments of the invention.

In addition, although an embodiment described herein is directed to a stride profiling guided prefetching, it will be appreciated by those skilled in the art that an embodiment of the present invention can be applied to other systems. In fact, systems for concurrent stride profile and frequency profile generation are within the embodiments of the present invention, without departing from the scope and spirit of the embodiments of the present invention. The embodiments described above were chosen and described in order to best explain the principles of the invention and its practical applications. These embodiment were chosen to thereby enable others skilled in the art to best utilize the invention and various embodiments with various modifications as are suited to the particular use contemplated.

It is to be understood that even though numerous characteristics and advantages of various embodiments of the present invention have been set forth in the foregoing description, together with details of the structure and function of various embodiments of the invention, this disclosure is illustrative only. In some cases, certain subassemblies are only described in detail with one such embodiment. Nevertheless, it is recognized and intended that such subassemblies may be used in other embodiments of the invention. Changes may be made in detail, especially matters of structure and management of parts within the principles of the present invention to the full extent indicated by the broad general meaning of the terms in which the appended claims are expressed.

The embodiments of the present invention provide many advantages over known techniques. One embodiment of the present invention includes the ability to concurrently perform collection of stride profile information using partially collected frequency profile information to form both a stride profile and a frequency profile during a single compiler frequency pass. Accordingly, the one pass profiling technique described by the embodiment of the invention enables stride profile guided prefetching, which is both practical and optimal. Utilizing the profiling method described by the embodiment, the software development process is simplified, while resulting in performance gains which conform to evaluation rules set by the Standard Performance Evaluation Corporation (SPEC) committee. Consequently, embodiments of the present invention enable the identification of regular stride patterns within irregular program code containing irregular data references in order to prefetch irregular data and avoid system stalls due to cache and data table misses.

Having disclosed exemplary embodiments and the best mode, modifications and variations may be made to the disclosed embodiments while remaining within the scope of the embodiments of the invention as defined by the following claims.

What is claimed is:

1. A method comprising:
selectively generating stride profile information according to concurrently generated frequency profile information to concurrently form a stride profile and a frequency profile according to user program code instrumented during a single compiler profiling pass; and
inserting prefetch instructions within a user program utilizing the stride profile and the frequency profile.

2. The method of claim 1, wherein prior to collecting the stride profile information, the method further comprises:
instrumenting a user program to collect frequency profile information to form the frequency profile;
instrumenting each load loop within the user program to selectively collect stride profile information utilizing partially collected frequency profile information; and
executing the instrumented user program to concurrently generate the stride profile and the frequency profile.

3. The method of claim 1, wherein selectively collecting the stride profile information further comprises:
detecting an instrumented user program loop wherein a data load instruction is performed as an instrumented load loop;
determining an average trip count of the detected loop according to partially generated frequency information of the detected loop;
when the average trip count of the detected loop exceeds a predetermined average trip count value, generating stride profile information for one or more loads within the detected loop; and
repeating the selecting, determining and collecting for each instrumented load loop within the user program.

4. The method of claim 1, wherein selectively collecting the frequency information further comprises:
once the stride profile is complete, determining one or more loads having an average trip count below the pre-determined average trip count;
selecting a load loop from the one or more determined load loops;
filtering, from the stride profile, stride profile information corresponding to the selected load loop; and
repeating the selecting and filtering for each of the one or more determined load loops to form a final stride profile.

5. The method of claim 2, wherein instrumenting the user program to collect frequency profile information further comprises:
selecting a program block/edge from the user program;
instrumenting the program block/edge to collect block/edge frequency profile information; and
repeating the selecting and instrumenting for each program block/edge within the user program to complete frequency instrumenting of the user program.

6. The method of claim 2, wherein instrumenting each load loop further comprises:
determining a plurality of loops within the user program where a data load instruction is performed as a plurality of load loops;
selecting a load loop from the plurality of load loops wherein a data load instruction is performed within the user program;
instrumenting a loop prolog of the selected load loop to set a loop predicate according to an average trip count condition of the selected load loop;
instrumenting one or more loads inside the selected load loop to selectively collect stride profile information according to the loop predicate; and
repeating the selecting of a load loop, instrumenting of a loop prolog and instrumenting one or more loads inside a loop for each of the plurality of determined load loops within the user program.

7. The method of claim 6, wherein instrumenting the loop prolog further comprises:
instrumenting the loop prolog to determine an average trip count of the selected load loop utilizing partially collected frequency information; and
instrumenting the loop prolog to set the loop predicate according to whether the average trip count exceeds a predetermined average trip count value to collect stride profile information when the average trip count exceeds the predetermined average trip count value.

8. The method of claim 6, wherein instrumenting the loop prolog further comprises:
instrumenting the loop prolog to determine an average trip count of the selected load loop utilizing partially collected frequency information;
instrumenting the loop prolog to determine an execution count of the selected load loop;
instrumenting the loop prolog to set a temporary loop predicate according to whether the execution count exceeds a predetermined average execution count value; and
instrumenting the loop prolog to set a loop predicate according to the temporary loop predicate, such that the loop predicate is not set according to the average trip count condition until the execution count exceeds a predetermined average execution count value.

9. The method of claim 6, wherein instrumenting the loop prolog further comprises:
instrumenting the loop prolog to determine an average trip count of the selected load loop utilizing partially collected frequency information;
instrumenting the loop prolog to set a temporary predicate according to whether the average trip count exceeds the predetermined average trip count value;
instrumenting the loop prolog to increment a high trip count according to the temporary loop predicate; and
instrumenting the loop prolog to set the loop predicate once the high trip count exceeds a predetermined high trip count value.

10. The method of claim 6 wherein instrumenting the loop prolog further comprises:
selecting a loop prolog block from one or more loop prolog blocks of the selected loop head block;
instrumenting the selected loop prolog to generate a prolog frequency total as a sum of a prolog frequency of each of the one or more prolog blocks of the selected loop ahead block;
instrumenting the selected loop prolog block to determine an average trip count as a ratio of a frequency of the selected loop head block and the prolog frequency total;
instrumenting the loop predicate to set according to whether the average trip count exceeds a predetermined average trip count value; and
repeating the instrumenting, instrument and instrumenting for each loop prolog block of the selected loop head block.

11. A computer readable storage medium including program instructions that direct a computer to function in a specified manner when executed by a processor, the program instructions comprising:
selectively generating stride profile information according to concurrently generated frequency profile information to concurrently form a stride profile and a frequency profile according to user program code instrumented during a single compiler profiling pass; and
inserting prefetch instructions within a user program utilizing the stride profile and the frequency profile.

12. The computer readable storage medium of claim 11, wherein prior to collecting the stride profile information, the method further comprises:
instrumenting a user program to collect frequency profile information to form the frequency profile;
instrumenting each load loop within the user program to selectively collect stride profile information utilizing partially collected frequency profile information; and
executing the instrumented user program to concurrently generate the stride profile and the frequency profile.

13. The computer readable storage medium of claim 11, wherein collecting the stride profile information further comprises:
detecting an instrumented user program loop wherein a data load instruction is performed as an instrumented load loop;
determining an average trip count of the detected loop according to partially generated frequency information of the detected loop;
when the average trip count of the detected loop exceeds a predetermined average trip count value, generating stride profile information for one or more loads within the detected loop; and
repeating the selecting, determining and collecting for each instrumented load loop within the user program.

14. The computer readable storage medium of claim 11, wherein selectively collecting the frequency information further comprises:
once the stride profile is complete, determining one or more load loops having an average trip count below the pre-determined average trip count;
selecting a load loop from the one or more determined load loops;
filtering, from the stride profile, stride profile information corresponding to the selected load loop; and
repeating the selecting and filtering for each of the one or more determined load loops to form a final stride profile.

15. The computer readable storage medium of claim 12, wherein instrumenting the user program to collect frequency profile information further comprises:
selecting a program block/edge from the user program;
instrumenting the program block/edge to collect block/edge frequency profile information; and
repeating the selecting and instrumenting for each program block/edge within the user program to complete frequency instrumenting of the user program.

16. The computer readable storage medium of claim 12, wherein instrumenting each load loop further comprises:
determining a plurality of loops within the user program where a data load instruction is performed as a plurality of load loops;
selecting a load loop from the plurality of load loops wherein a data load instruction is performed within the user program;
instrumenting a loop prolog of the selected load loop to set a loop predicate according to an average trip count condition of the selected load loop;
instrumenting one or more loads within the selected load loop to selectively collect stride profile information according to the loop predicate; and
repeating the selecting of a load loop, instrumenting a loop prolog and instrumenting one or more loads inside a loop for each of the plurality of determined load loops within the user program.

17. The computer readable storage medium of claim 16, wherein instrumenting the loop prolog further comprises:
instrumenting the loop prolog to determine an average trip count of the selected load loop utilizing partially collected frequency information; and
instrumenting the loop to set the loop predicate according to whether the average trip count exceeds a predetermined average trip count value to collect stride profile information when the average trip count exceeds the predetermined average trip count value.

18. The computer readable storage medium of claim 16, wherein instrumenting the loop prolog further comprises:
instrumenting the loop prolog to determine an average trip count of the selected load loop utilizing partially collected frequency information;
instrumenting the loop prolog to determine an execution count of the selected load loop;
instrumenting the loop prolog to set a temporary loop predicate once the execution count exceeds a predetermined execution count value; and
instrumenting the loop predicate to set according to whether the average trip count exceeds a predetermined average trip count value once the temporary loop predicate is set.

19. The computer readable storage medium of claim 16, wherein instrumenting the loop prolog further comprises:
instrumenting the loop prolog to determine an average trip count of the selected load loop utilizing partially collected frequency information;
instrumenting the loop prolog to set a temporary predicate according to whether the average trip count exceeds the predetermined average trip count value;
instrumenting the loop prolog to increment a high trip count according to the temporary loop predicate; and
instrumenting the loop prolog to set the loop predicate once the high trip count exceeds a predetermined high trip count value.

20. The computer readable storage medium of claim 16 wherein instrumenting the loop prolog further comprises:
selecting a loop prolog block from one or more loop prolog blocks of the selected loop head block;
instrumenting the selected loop prolog to generate a prolog frequency total as a sum of a prolog frequency of each of the one or more prolog blocks of the selected loop head block;
instrumenting the selected loop prolog block to determine an average trip count as a ratio of a frequency of the selected loop head block and the prolog frequency total;
instrumenting the loop predicate to set according to whether the average trip count exceeds a predetermined average trip count value; and
repeating the instrumenting, instrument and instrumenting for each loop prolog block of the selected loop head block.

21. A method comprising:
instrumenting a user program to generate frequency profile information to form a frequency profile;
instrumenting each loop within the user program to selectively generate stride profile information utilizing concurrently generated frequency profile information during a single compiler profiling pass; and
executing the instrumented user program to concurrently generate the stride profile and the frequency profile.

22. The method of claim 21, wherein instrumenting the user program to collect frequency profile information further comprises:
selecting a program block/edge from the user program;
instrumenting the program block/edge to collect block/edge frequency profile information; and
repeating the selecting and instrumenting for each program block/edge within the user program.

23. The method of claim 21, wherein instrumenting each load loop further comprises:
determining a plurality of loops within the user program where a load instruction is performed;
selecting a load loop from the plurality of loops wherein a load instruction is performed;
instrumenting a loop prolog of the selected load loop to set the loop predicate according to an average trip count condition of the selected load loop;
instrumenting one or more loads within the selected load loop to selectively collect stride profile information according to the loop predicate; and
repeating the selecting, instrumenting and instrumenting for each of the plurality of determined load loops within the user program.

24. The method of claim 23, wherein instrumenting the loop prolog block further comprises:
instrumenting the loop prolog to determine an average trip count of the selected load loop utilizing partially collected frequency information; and
instrumenting the loop prolog to set the loop predicate according to whether the average trip count exceeds a predetermined average trip count value, to collect stride profile information when the average trip count exceeds the predetermined average trip count value.

25. The method of claim 21, further comprising:
selectively generating stride profile information according to partially generated frequency profile information to concurrently form the stride profile and the frequency profile during execution of the instrumented user program; and
inserting prefetch instructions within the user program utilizing the concurrently generated stride profile and frequency profile.

26. A computer readable storage medium including program instructions that direct a computer to function in a specified manner when executed by a processor, the program instructions comprising:
instrumenting a user program to generate frequency profile information to form a frequency profile;
instrumenting each loop within the user program to selectively generate stride profile information utilizing concurrently generated frequency profile information during a single compiler profiling pass; and
executing the instrumented user program to concurrently generate the stride profile and the frequency profile.

27. The computer readable storage medium of claim 26, wherein instrumenting the user program to collect frequency profile information further comprises:
selecting a program block/edge from the user program;
instrumenting the program block/edge to collect block/edge frequency profile information; and
repeating the selecting and instrumenting for each program block/edge within the user program.

28. The computer readable storage medium of claim 26, wherein instrumenting each load loop further comprises:
determining a plurality of loops within the user program where a load instruction is performed;
selecting a load loop from the plurality of loops wherein a data load instruction is performed;
instrumenting a loop prolog of the selected load loop to set a loop predicate according to an average trip count condition of the selected load loop;
instrumenting one or more loads of the selected load loop to selectively collect stride profile information according to the loop predicate; and
repeating the selecting, instrumenting and instrumenting for each of the plurality of determined load loops within the user program.

29. The computer readable storage medium of claim 28, wherein instrumenting the loop prolog block further comprises:
instrumenting the loop prolog to determine an average trip count of the selected load loop utilizing partially collected frequency information; and
instrumenting the loop prolog to set the loop predicate according to whether the average trip count exceeds a predetermined average trip count value to collect stride profile information when the average trip count exceeds the predetermined average trip count value.

30. The computer readable storage medium of claim 26, further comprising:
selectively generating stride profile information according to partially generated frequency profile information to concurrently form the stride profile and the frequency profile during execution of the instrumented user program; and
inserting prefetch instructions within the user program utilizing the concurrently generated stride profile and frequency profile.

31. A system comprising:
a processor having circuitry to execute instructions;
a communications interface coupled to the processor, the communications interface to receive a user program from a user and to provide a compiled target program executable to the user;
a storage device coupled to the processor, having sequences of instructions stored therein, which when executed by the processor cause the processor to:
instrument a user program to generate frequency profile information,
instrument each load loop within the user program to selectively generate stride profile information utilizing concurrently generated frequency profile information during a single compiler profiling pass, and
execute the instrumented user program to concurrently generate the stride profile and the frequency profile.

32. The system of claim 31, wherein the processor is further caused to:
select a frequency profile and a stride profile concurrently generated during execution of the user program instrumented during a single compiler profiling pass; and
insert prefetch instructions within the user program utilizing the stride profile and the frequency profile.

33. The system of claim 32, wherein the processor is further caused to:
execute, in response to a user request, an instrumented, target program executable; and
prefetch program data according to the inserted prefetch instructions.
